(19) United States
(12) Patent Application Publication
(10) Pub. No.: US 2007/0038609 A1
(43) Pub. Date: Feb. 15, 2007

(54) System and method of query paraphrasing

(76) Inventor: William Wu, Fremont, CA (US)

Correspondence Address: OBER/KALER, 120 East Baltimore Street, Baltimore, MD, 21202-1643, US

(21) Appl. No.: 11/499,368

(22) Filed: Aug. 4, 2006

Related U.S. Application Data
(60) Provisional application No. 60/707,422, filed on Aug. 11, 2005.

(51) Int. Cl. G06F 17/30

(52) U.S. Cl. 707/3

(57) ABSTRACT

A platform-independent process for data retrieval from ontology-oriented data systems over computer networks through a flexible system and method of query paraphrasing. The present invention uses a “common ontology” that is not tied to any particular data system. Thus, each client computer issues queries to a target data system in the common ontology. Of course, the target data system will not be able to directly process the query (as it is not in its local ontology). Instead, the query is first paraphrased back from the common ontology into local ontology by taking the semantic query, passing it through a query paraphraser, and then sending the paraphrased query to the data system. Once it is paraphrased successfully, the target data system can process it and produce a result using local ontology. The result may then be sent from the data system to an answer paraphraser for paraphrasing, and the paraphrased answer may be returned to its original query issuer and on to the client.

### CROSS-REFERENCE TO RELATED APPLICATIONS

The present application derives priority from U.S. Provisional Patent Application No. 60/707,422 filed Aug. 11, 2005.

### BACKGROUND OF THE INVENTION

1. Field of the Invention

The present invention relates to computer search queries and, more particularly, to a system and method for highly scalable data integration through query mapping and paraphrasing of query terms.

2. Description of the Background

The world is full of useful data records stored in wide varieties of data systems. Some are in relational databases, some are in object-oriented systems, some are in spreadsheets, and some are in XML documents. In any computer network, when a program, herein referred to as a “client”, would like to retrieve data from another computer program, herein referred to as “data system”, that holds the data, it typically issues a query to the data system, herein referred to as the “target data system”. A data system may have its own ontology, herein referred as “local ontology”, that is different from each other. It can only process queries in its own local ontology. Therefore, in order for a query to be processable by a target data system, a client must compile a local query in the local ontology of the target data system. For example, a query to a relational database not only must be in SQL, it also must conform to its table and column specifications. This means that whenever a program wants to retrieve information from many diverse data systems, it must compile different queries for each of them. The programming overhead and cost is very high. Effort has been made to address this problem, such as ETL (extract, transfer, and load), data warehouse, and federated databases, with limited success. ETL is the process of pulling data from various data systems, transforming the data so that it is optimized for usage in a data warehouse, and loading the data into a data warehouse.

Data system administration involves knowing your data system from the ground up. This includes completely understanding both the logical and physical design of the data system, thoroughly understanding the platform on which the database resides, understanding the users of the data system in terms of security and access required, understanding the type of business functions each user will perform and understanding the network by which data is transmitted. In summary, to be a data system administrator, you must know everything about your organization and its computer network. The data system administrator must profoundly rationalize each element of the system in order to completely optimize the data system and to prepare it for continuous improvement.

“Swatting flies” is the old DBA (database administrator) paradigm where the DBA is placed on call to fix ticket orders and to fine-tune data systems. However, there are new and innovative DBA concepts aimed at getting a data system into statistical control in order to identify and avoid common and special problems.

Structured Query Language (“SQL”) has evolved as the standard language used by computers to understand what, where and how data is to be stored and manipulated. Logical and Physical data system designs are implemented using SQL allowing for computer systems to mange data according to user specifications.

Procedural Language SQL is an extension of SQL that takes advantage of the powerful features that are common to C, Java and other 3rd generation programming languages. It actually stems from the 3rd generation language, ADA, although significant efforts are being made to make PL/SQL work more effectively with Java. In any case, PL/SQL uses procedures, functions, variables and loops to make SQL a more efficient asset.

Dynamic SQL is an extension of SQL that allows a data system to consider input that is developed during run-time. Hence, data that is only determined by computation or a derivative of system execution can be gathered at run-time and injected into the appropriate position in a SQL or PL/SQL script.

Oracle is a vendor that delivers high-powered data systems. After learning languages such as SQL, etc., Oracle data systems are ideal for database design and implementation on both a small and large scale. Although Oracle is well into its release of 10 g, Oracle 9i is sufficient in developing data systems at an industry standard.

Data Modelers make some aspects of data system design easier by providing graphical user interfaces (GUIs) and by writing SQL code based on GUI input. Although using data modelers helps developers to avoid programming, if you've ever created a webpage using Frontpage or DreamWeaver you know that helper applications often give you what you want plus a whole lot of what you don't need. Nonetheless, good data modelers, such as Erwin, have advanced features that make using the software worthwhile.

BrioQuery is a handy tool that presents large amounts of data (from data systems) in user-friendly formats, such as charts and graphs. It allows for network connectivity to established databases and then represents these databases using various advanced utilities.

In recent years there have been significant research efforts directed to knowledge base systems and the Semantic Web, a project that intends to create a universal medium for information exchange by giving meaning (semantics), in a manner understandable by machines, to the content of documents on the Web. Currently under the direction of the World Wide Web Consortium, the Semantic Web project is aimed at extending the ability of the World Wide Web through the use of standards, markup languages and related processing tools.

The subject of ontology is the study of the categories of things that exist or may exist. The product of such a study, called an ontology, is a catalog of the types of things that are assumed to exist in a domain of interest from the perspective of a person who uses a language for the purpose of talking about that domain. A formal ontology is specified by a collection of names for concept and relation types organized in a partial ordering by the type-subtype relation. Unfortunately, formal ontologies are more easily dreamed of than accomplished. “The task of classifying all the words of language, or what's the same thing, all the ideas that seek expression, is the most stupendous of logical tasks. Anybody but the most accomplished logician must break down in it utterly; and even for the strongest man, it is the severest possible tax on the logical equipment and faculty.” Charles Sanders Peirce, letter to editor B. E. Smith of the Century Dictionary.

Due to the diversity of the world, it is simply not possible to have a single ontology to cover all concepts. Data system based on one ontology can only understand queries in that ontology. However, each organization and each profession would like to have their own ontology. Consequently, to obtain information from many data systems currently requires multiple queries, which is inefficient. Moreover, when the number of data systems is large it becomes impossible. Clearly, a mechanism is needed to enable a single query statement to query multiple data systems in different ontology.

It would be greatly advantageous to use an ontology as the core component of a data system, and to provide an interpretive reasoning methodology in order to address the common maintenance and accessibility problems. An ontology-oriented data system can potentially represent both object oriented databases and relational databases, and data in most existing data systems can be either be ported or translated into ontology-oriented data systems. Therefore, an efficient, cost-effective, and highly scalable ontology-oriented data system is needed, as well as data retrieval methods there from. Such system must necessarily include the semantics associated with content, a mechanism to compile a semantic annotation which deduces implicit knowledge from that which is explicitly given, and a basic syntactic query mechanism that uses the given semantics. Given the foregoing, we would have a query engine that can find what a user means, rather than simply what they type.

### SUMMARY OF THE INVENTION

It is, therefore, the primary object of the present invention to provide a novel and highly scalable ontology-oriented system and method for paraphrasing semantic queries.

It is another object to provide a plurality of software components necessary for implementing the above-described system, inclusive of: 1) a dictionary that stores descriptions of an ontology, and provides services for description of terms, subsumption relationship between terms, etc.; 2) a query paraphraser that can paraphrase a semantic query in common ontology into a semantically equivalent query or a semantically implicative query in local ontology; 3) an answer paraphraser that can paraphrase the query result in the original query language.

According to the present invention, the above-described and other objects are accomplished by a process for data retrieval from ontology-oriented data systems over computer networks through a flexible system and method of query paraphrasing. The present invention proposes a “common ontology”, e.g., an ontological categorization of terms that is not tied to any particular data system. Thus, instead of using local ontology, a client can issue queries in common ontology. Of course, a target data system will not be able to directly process a query that uses terms not in its local ontology. The query must first be paraphrased back from common ontology into local ontology. According to the present invention this is accomplished by taking the semantic query, passing it through a query paraphraser, and then sending the paraphrased query to the data system. Once it is paraphrased successfully, the target data system can process it and produce a result using local ontology. The result may then be sent from the data system to an answer paraphraser for paraphrasing, and the paraphrased answer may be returned to its original query issuer and on to the client. Both the process and architecture inclusive of query paraphraser and result (or answer) paraphraser are disclosed in detail in multiple embodiments.

Even though the present invention is designed to query data systems in target ontology, it can also be used for paraphrasing queries from source ontology to target ontology without any specific data system in target ontology. In this case, the data system is a virtual data system.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram illustrating a typical general-purpose computer system of the type representative of the preferred embodiment.

FIG. 2 is a block diagram illustrating a representative computer network system in which the present invention operates.

FIG. 3 is a block diagram illustrating a two-step query translation architecture where the query is first processed by a paraphraser, then processes by a translator.

FIG. 4 is a block diagram illustrating the process of sending query by a client to an ontology-oriented data system and obtaining the result back.

FIG. 5 is a block diagram illustrating the process of query processing with two cascading paraphraser.

FIG. 6(A-D) shows an example of an ontology that will be used as common ontology in later examples.

FIG. 7(A-D) shows another example of another ontology that will be used as local ontology in later examples.

FIG. 8(A-E) shows an example of an ontology-oriented data system based on RDF.

FIG. 9A shows a cascade dictionary structure with target dictionary in front of the source dictionary.

FIG. 9B shows a containment dictionary structure in which the target ontology is treated as a part of the source ontology.

FIG. 10 illustrates architecture of a paraphrasing system.

FIG. 11 shows the syntax and semantics of the canonical form.

FIG. 12A-12B shows examples of semantic query in canonical form, SPARQL, RQL, and ONQL.

FIG. 13 shows the interface architecture of the dictionary.

FIG. 14(A-Q) shows the process of query paraphrasing for the canonical form.

FIG. 15 shows an example of a query and its table style query result.

FIG. 16 shows example of context and contextual based definitions.

### DETAILED DESCRIPTION OF THE PREFERRED EMBODIMENT

The present invention is a process for data retrieval from ontology-oriented data systems over computer networks through a flexible system and method of query paraphrasing. The present invention proposes a “common ontology”, e.g., an ontological categorization of terms that is not tied to any particular data system. Though this common ontology may overlap with many data systems' local ontology, in general, the common ontology is broader and covers more concepts. Thus, instead of using local ontology, a client can issue queries in common ontology. Of course, a target data system will not be able to directly process a query that uses terms not in its local ontology. The query must first be paraphrased back from common ontology into local ontology. Once it is paraphrased successfully, the target data system can process it and produce a result using local ontology. The result is then paraphrased back to the terms used in the original query, and sent back to the client.

Overall Architecture

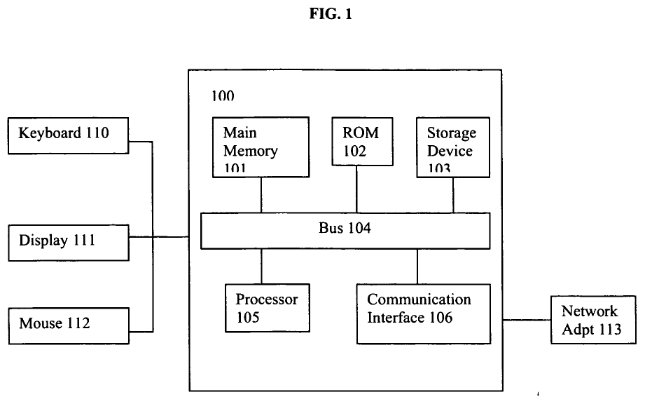

The overall architecture of the present system is described with respect to FIGS. 1-3.

FIG. 1 illustrates a suitable computer for use in the system for query mapping and paraphrasing according to the present invention. The system comprises a main unit 100 and a keyboard 110, a display device 111, a mouse 112, and network adapter 113 for connecting to a network. The main unit 100 also comprises a main memory 101, ROM 102, a storage device 103, a processor 105, a communication interface 106, and a bus 104. It can be a conventional Personal Computer, Server, or any other computer system as described.

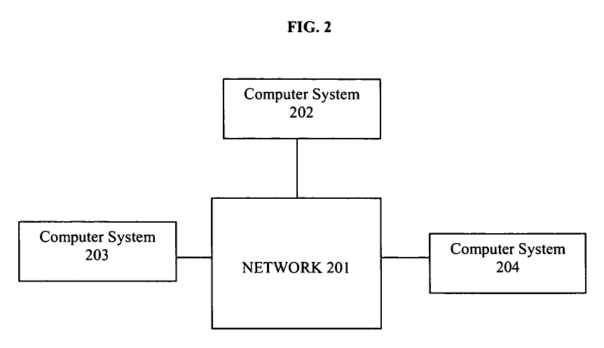

FIG. 2 illustrates a computer network which may be used to run the system for query mapping and paraphrasing according to the present invention. It comprises a plurality of computers 202, 203, and 204 as in FIG. 1, and a network 201. The network 201 may be an Ethernet, Internet, or any other computer network.

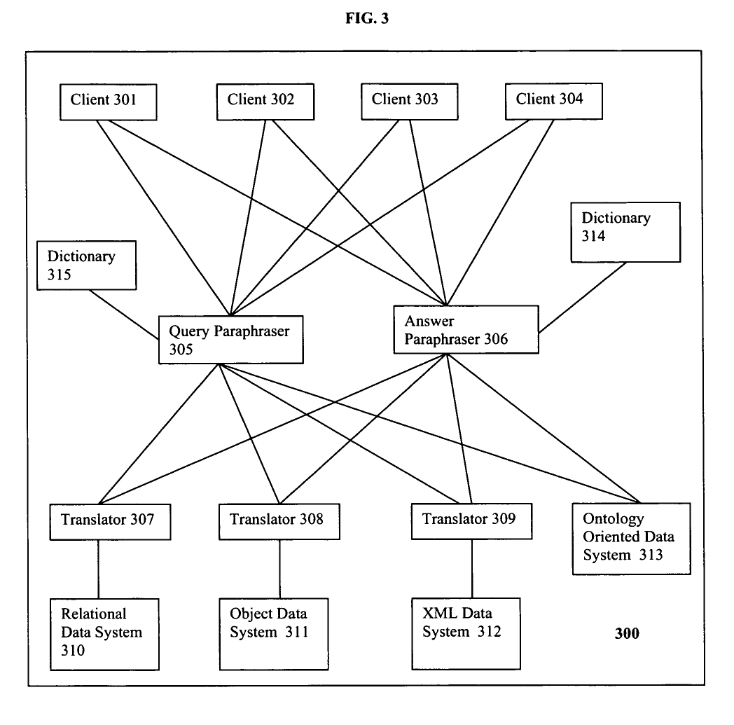

FIG. 3 is a block diagram of the architecture for the system for query mapping and paraphrasing according to the present invention. It comprises a plurality of clients 301-304, Ontology Oriented Data System 313, translators 307-309, dictionaries 314-315, query paraphrasers 305, answer paraphrasers 306, Relational Database 310, Object Data System 311, and XML Data System 312. There are no restrictions on the numbers of these components. All of them can run on a single computer, or on different computers in a network.

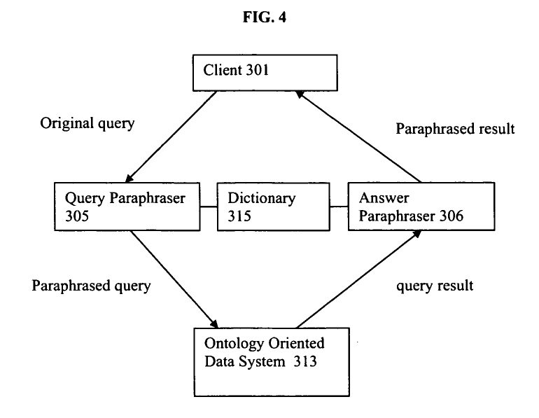

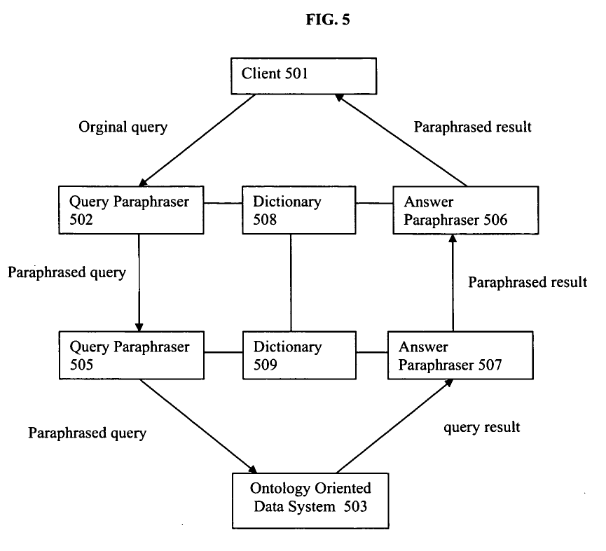

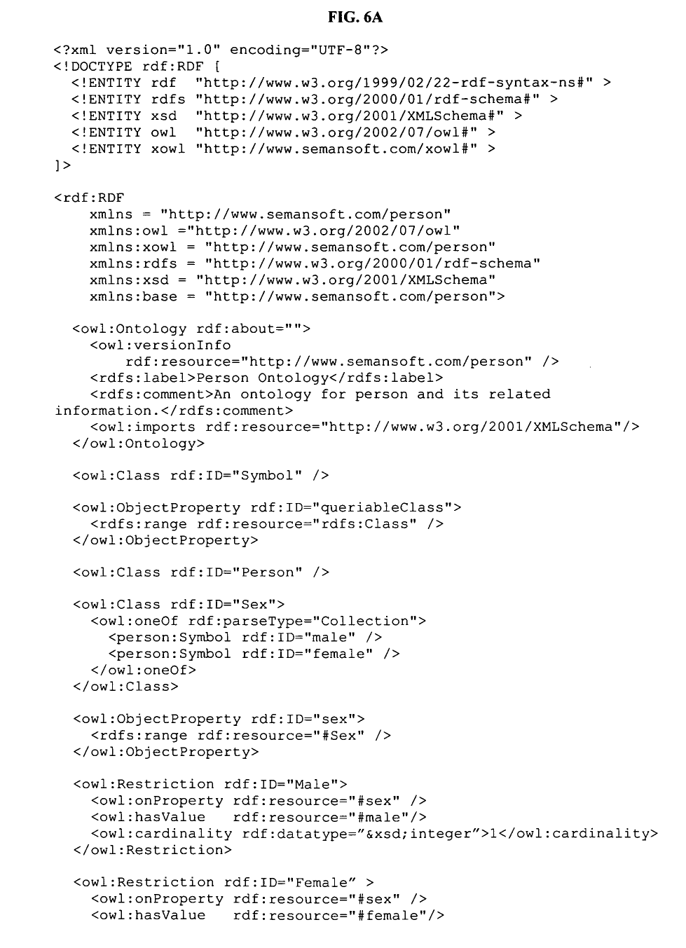

FIG. 4 is a flow chart illustrating the overall operations of the architecture of FIG. 3, as described below. The data system 313 may be an ontology oriented data system or not. For a non-ontology oriented data system, a translator 307-309 can be placed in front of Relational Database 310, Object Data System 311, and XML Data System 312 as shown in FIG. 3 to emulate an ontology oriented system.

Dictionary 315 holds the ontology that is stored before the query. It may contain a mechanism that accepts publication of its local ontology. Such mechanism is well known, hence not described.

Overall Operations

The overall operations of the system for query mapping and paraphrasing according to the present invention is herein described with combined reference to FIGS. 1-4, as described above.

When a client 301 wants to obtain data from the data system 313, it issues a query in semantic query language with common ontology. The query is sent to a query paraphraser 305. The query paraphraser 305 paraphrases the query into local ontology of the data system 313. When the parapharser 305 is in operation, it may require the service of the dictionary 315 for operations on ontology. The paraphrased query is sent to the data system 313 for processing. After processing, the result is returned in local ontology. If necessary, it will also be paraphrased into common ontology.

The query paraphrasing process must convert the original query into a semantically equivalent query or a semantically implicative query. A query Q2 is semantically implicative query of Q1 if any solution to Q2 is also a solution to Q1. If Q2 and Q2 are semantically implicative to each other, then they are semantically equivalent.

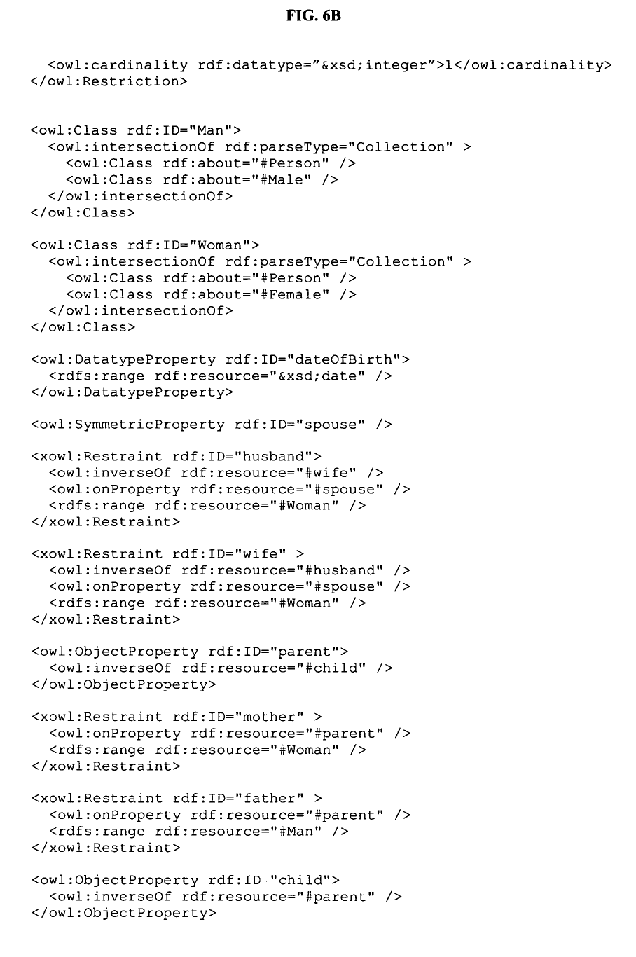

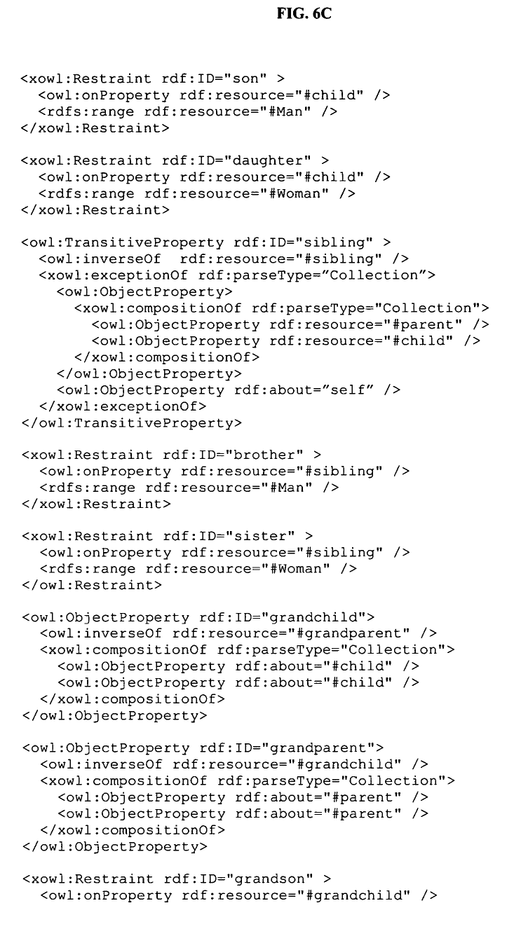

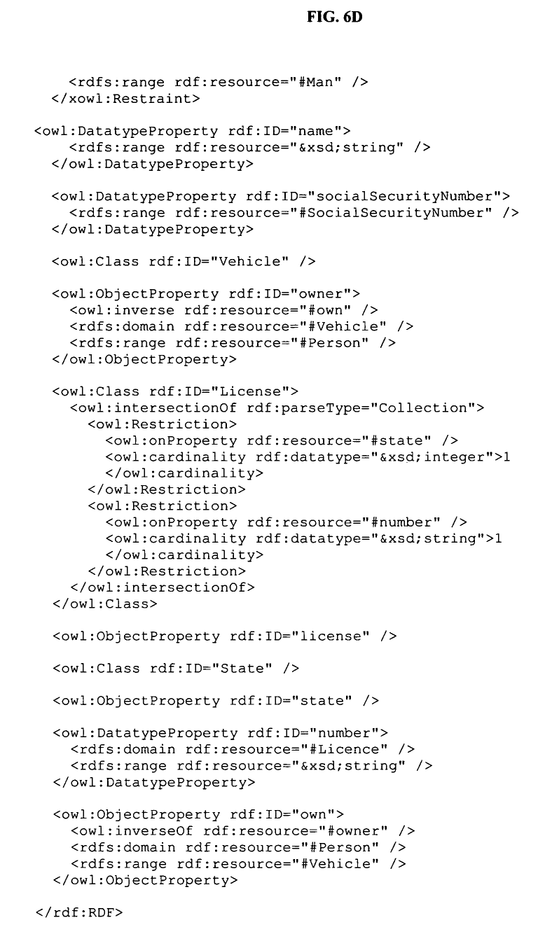

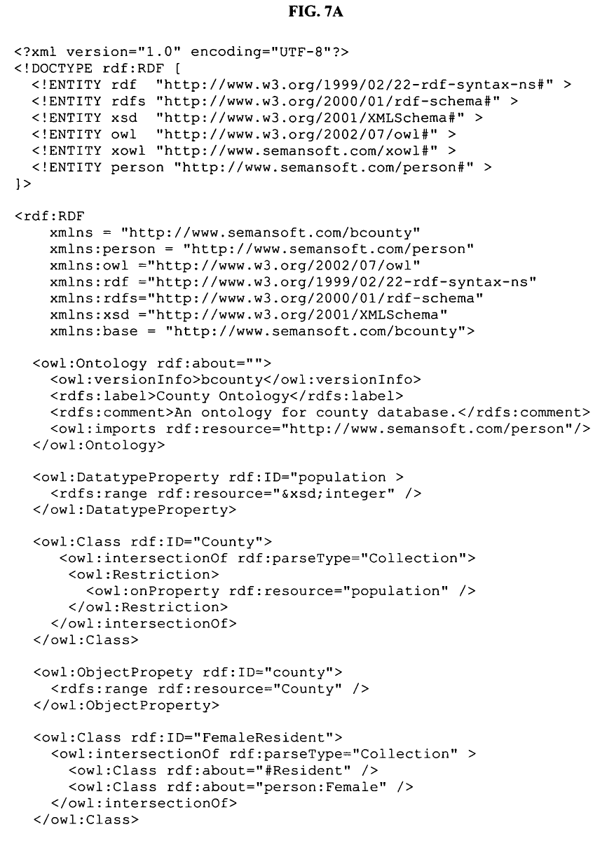

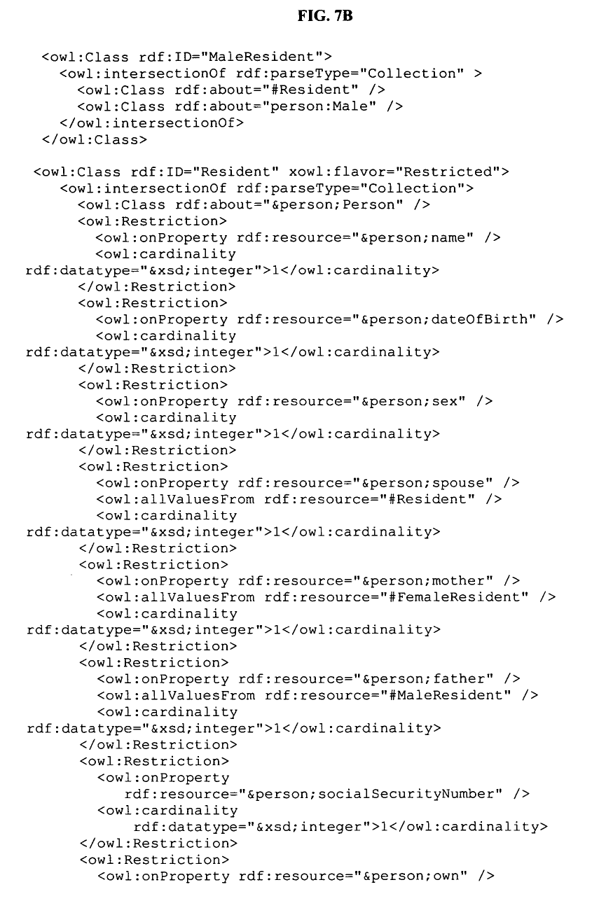

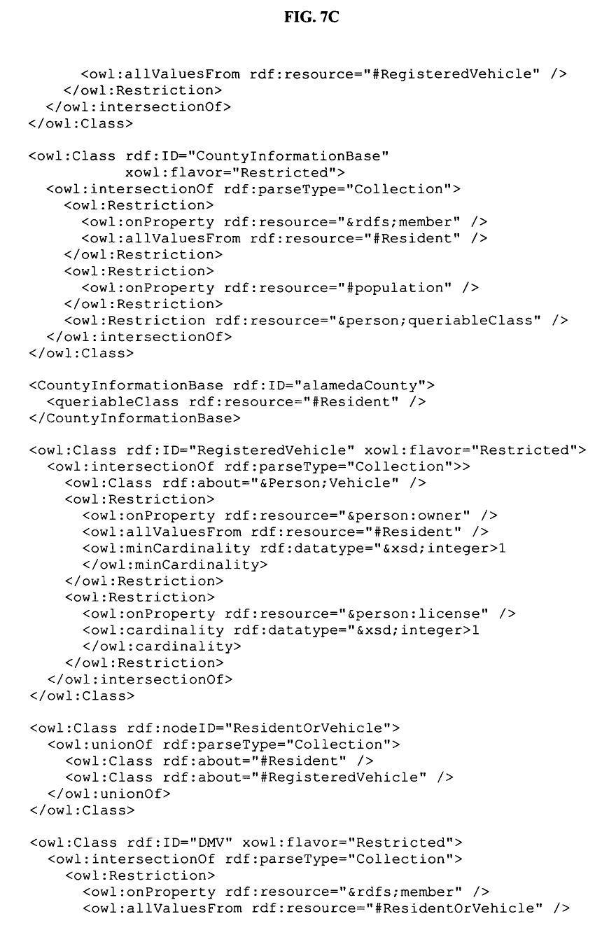

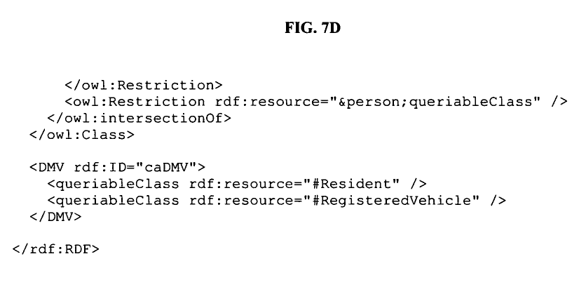

For example, client 301 would like to obtain the names of the wife of all persons named John Wilson from the data system 313. We define in FIG. 6(A-D) a common ontology for the network and in FIG. 7(A-D) a local ontology for the data system 313.

FIGS. 6(A-D) and 7(A-D) show examples of the two ontologies in XOWL language (described below). Because local ontology can refer to common ontology in its description but common ontology cannot refer to local ontology in its description, the ontology in FIG. 6(A-D) can be a common ontology and the ontology in FIG. 7(A-D) can be a local ontology, but not vice versa.

Every data system is represented as an individual with a universal resource identifier, also known as URL. It is an instance of a class. In general, a data system can have properties and is a “container” (a term used in Resource Definition Framework or “RDF”, a World Wide Web Consortium standard, to describe any resource that can contain individuals). FIG. 7(A-D) also shows an individual called “alamedaCountyInformation” to represent a data system. Its class is “CountylnformationBase”. It has property called “county”. It also can have content whose type must be “Resident”.

For example, assume that Client 301 issues the ONQL query . . .

| all \hat{ }Person[that/name==“John Wilson”]/wife/name be $N2 | | |
|---|---|---|
| Or a RQL query, | | |
| SELECT N2 | | |
| FROM Person{X}.name {N}, {X} wife.name {N2} | | |
| WHERE N = “John Wilson” | | |
| Or a SPARQL query (prefix omitted), | | |
| SELECT ?N2 | | |
| WHERE { | | |
| ?X | rdf:type Person . | |
| ?X | name | “John Wilson” . |
| ?X | wife | ?wife . |
| ?wife | name | ?N2 . |

}
Or a canonical form,
Result N2;
X = ALL( );
TRUE = instance(Person, X);
N = name(X);
TRUE = EQUAL(N, “John Wilson”);
W = wife(X);
N2 = name(W);

The query is sent to the query paraphraser 305. It is paraphrased with local ontology into a semantic implicative query,

```
all \hat{ }Resident[that/name==“John Wilson”]/ spouse[that/sex==female]/name
be $N2
Or a RQL query,
SELECT N2
FROM Resident{X}.name {N},
  {X} spouse{S}.name {N2}, {S} sex {S2}
WHERE N = “John Wilson” AND S2 = female
Or a SPARQL form,
SELECT ?N2
WHERE {
  ?X rdf:type Resident .
  ?X name “John Wilson” .
  ?X spouse ?S .
  ?S name ?N2 .
  ?S sex female .
}
Or a canonical form,
Result N2;
X = ALL( );
TRUE = instance(Resident, X);
N = name(X);
TRUE = EQUAL(N, “John Wilson”);
S = spouse(X);
S2 = sex(S);
TRUE = EQUAL(S2, female);
N2 = name(S);
```

It seeks to find all names of the spouse, whose sex is female, of all residents in this system whose name is John Wilson. Because all Persons in the data system 313 are Residents in the system, the query paraphraser replaces “Person” with “Resident”. This is an implicative paraphrasing because Resident is just a subclass of, not equivalent class to, Person.

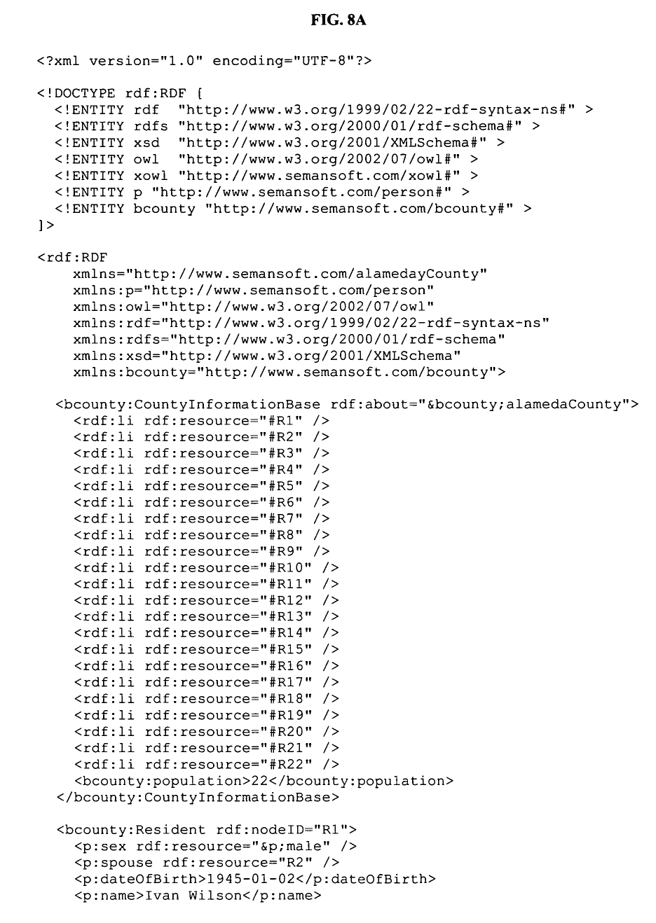

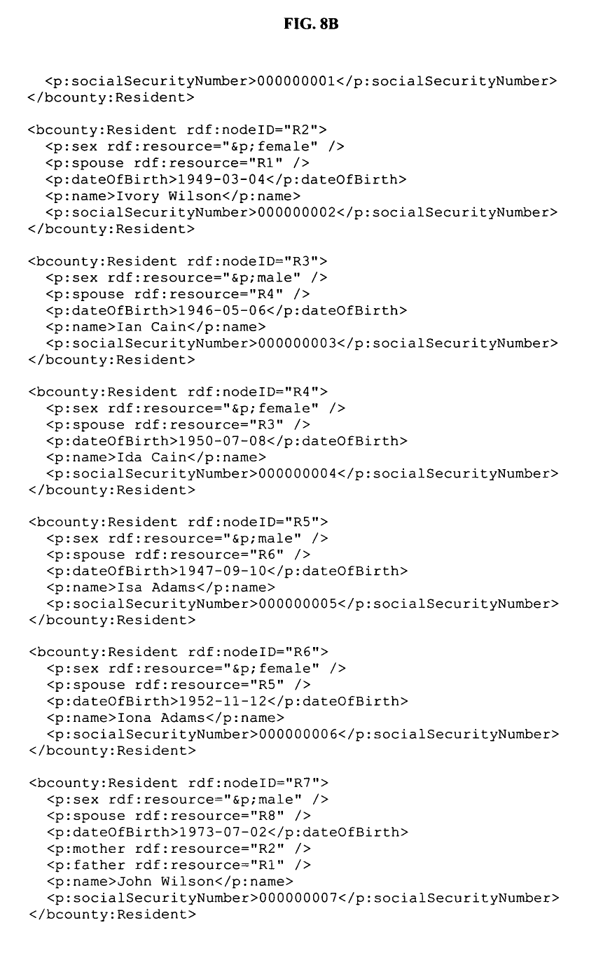

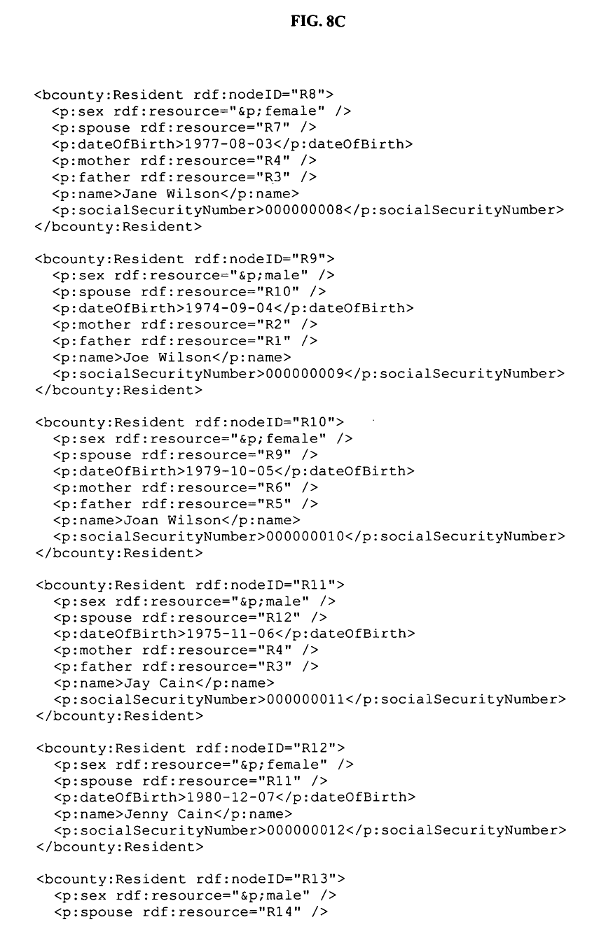

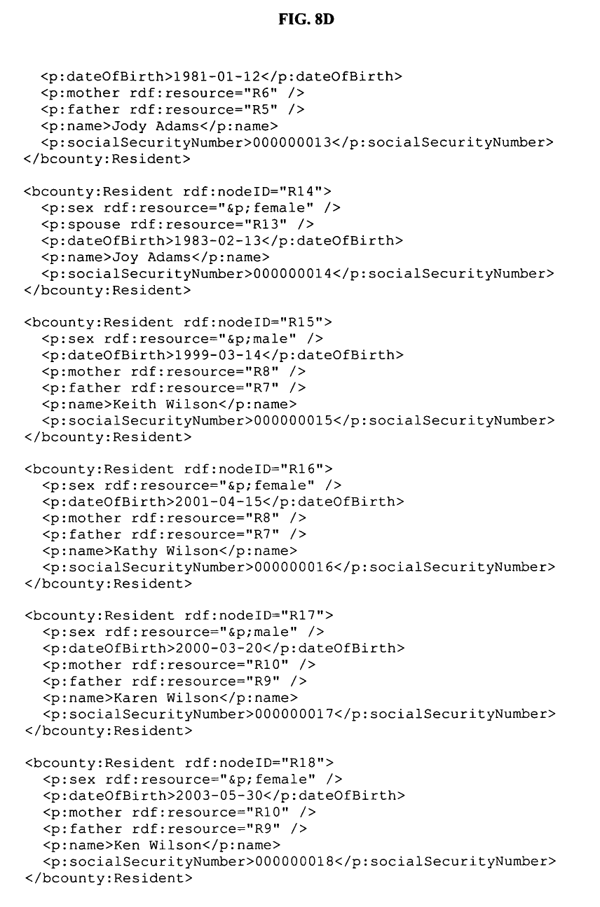

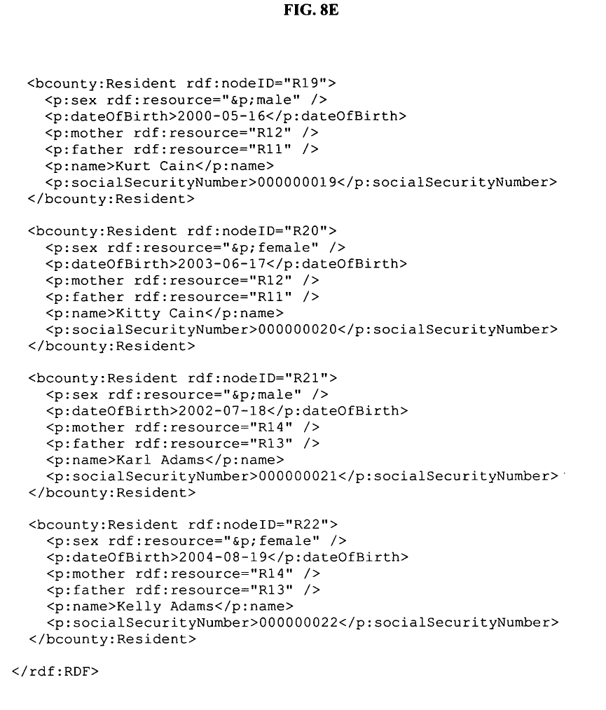

FIG. 8(A-E) shows an example of possible data in the data system 313. The result of the query will be a single column with a single entry, which is “Jane Wilson”.

```
<xowl:QueryResult>
  <rdf:li>
    <xowl:Column rdf:about=“#N2”>
      <rdf:li rdf:datatype=“&xsd;string”>Jane Wilson</rdf:li>
    </xowl:Column >
  </rdf:li>
</xowl:QueryResult>
```

Because N2 is in original ontology, there is no paraphrasing is needed in the answer. It can be directly sent back to client 301, or the answer paraphraser will do nothing and let it pass through. If the result is in a different format, such as

```
<rdf:RDF>
  <Resident>
    <spouse name=“Jane Wilson” />
  </Resident>
</rdf:RDF>
```

The answer paraphraser 306 will paraphrase the answer using the query ontology into,

```
<rdf:RDF>
  <Person>
    <wife name=“Jane Wilson” />
  </Person>
</rdf:RDF>
```

It then returns the result back to the client 301.

The above operations have several variations. On the query operation, the query issued by client 301 can be directly sent to 313. The data system 313 first checks whether it is in local ontology. If it is not, the data system 313 can send it to the query paraphraser 305 for paraphrasing. In addition, the client 301 can ask the query paraphraser 305 to paraphrase the query then return the paraphrased query back to itself. Then it can issue the paraphrased query to the translator 313 directly. On the answer operation, the data system 313, instead of producing a RDF document, can return a table result back to the client 301. The column name in the result table will be labeled as N2, as described above. The client 301 can match the column name with the query label to get the proper result.

It is possible to chain paraphrasers as shown in FIG. 5. For example, the whole Internet may have a single common ontology, while a company's intranet has another common ontology that depends on the Internet's common ontology. That is, the intranet's common ontology is just like local ontology to the Internet's ontology. A query from a client on the Internet to a data system in the intranet can be paraphrased first into the intranet's ontology, and then paraphrased into the local ontology of the data system.

Paraphrasing Overview

Paraphrasing is the process that takes a statement in one ontology and produces a semantically equivalent or implicative statement in a different ontology. A query paraphrasing process converts query statements, and an answer paraphrasing process converts answers to queries.

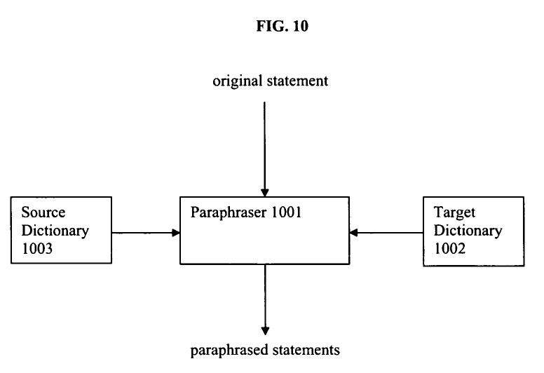

FIG. 10 generally illustrates a paraphrasing architecture. It consists of a paraphraser 1001, a source dictionary 1003, and a target dictionary 1002. The source dictionary 1003 contains the source ontology; the target dictionary 1002 contains target ontology. The paraphraser 1001 accepts statements in source ontology, executes a paraphrasing process using the ontology in dictionaries, and produces paraphrased statements in the target ontology.

Though paraphraser 1001 uses dictionaries, dictionaries do not have to run on the same system with the paraphraser. In addition, dictionaries may be specialized to hold different kinds of terms. When a term is not found, the term may be sent to other dictionaries for answers. The target ontology and the source ontology may overlap. Therefore, both target and source dictionary declare the same term, it must be identical. It is also possible to have one dictionary that refers to another dictionary for the descriptions of certain terms.

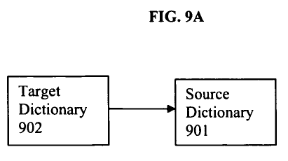

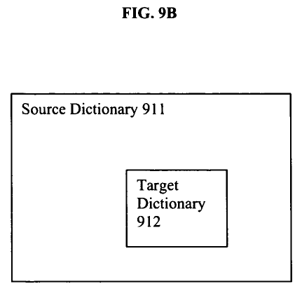

Conceptually, the target ontology can be viewed as a part of the source ontology. Therefore, the paraphrasing process becomes a restriction on terms used in a sentence. This concept allows the target dictionary to be viewed as a part or subset of the source dictionary, as shown in FIG. 9B, in which case the target and the source dictionaries can be combined into one dictionary. Alternatively, the source and target dictionaries can also be chained together with target dictionary in front as shown in FIG. 9A. In either case the paraphrasing system must define a way to identify the target ontology in the target dictionary such as exhausted enumeration of terms, special namespace, etc.

Ontology Language

There is no restriction on the ontology languages to be used in the present invention, such as DAML, OIL, or DAML+OIL. The preferred embodiment uses the Web Ontology Language, herein referred to as “OWL”, from the World Wide Web Consortium with extensions, herein referred to as “XOWL”, to describe its ontology. The extensions are in the XOWL namespace and are as follows.

1. A restraint on property description

2. The composition of two or more property descriptions

3. The intersection of two or more property descriptions

4. The union of two or more property descriptions

5. The exception between two property descriptions

6. The computeValueFrom between a property and a formula

7. The flavor of class.

A restraint on a property is a special kind of property description. It describes an anonymous property that is derived from another property that satisfies a set of constraints on its range, and/or its domain. The following example describes the property as a spouse whose range is Woman and whose domain is Man. Usually it is called “wife”.

```
<xowl:Restraint>
  <owl:onProperty rdf:resource=”spouse” />
  <rdfs:domain rdf:resource=“Man” />
  <rdfs:range rdf:resource=”Woman” />
</xowl:Restraint>
```

The compositionOf property links a property to a list of property descriptions. A compositionOf statement describes an anonymous property such that for any subject and object pair, x and y that is related through this property, there exists a sequence of z1, z2, etc., such that x and z1 is related through the first property in the list of property descriptions, z1 and z2 is related through the second property, and so on. y and the last of z in the sequence are related through the last property in the list of property descriptions.

The following example describes the property as the composite property of parent and mother. Usually it is called “grandmother”.

<owl:ObjectProperty>

```
  <xowl:compositionOf rdf:parseType=”Collection” >
    <owl:ObjectProperty rdf:about=”parent” />
    <owl:ObjectProperty rdf:about=”mother” />
  </xowl:compositionOf>
</owl:ObjectProperty >
```

The intersectionOf property links a property to a list of property descriptions. An intersectionOf describes an anonymous property for which any subject and object pair is also the subject and object pair of all property descriptions in the list. The following example describes a property for one's siblings and self, excluding half brothers and half sisters.

```
<owl:ObjectProperty>
  <xowl:intersectionOf rdf:parseType=”Collection” >
    <owl:ObjectProperty>
      <xowl:compositeOf rdf:parseType=”Collection” >
        <owl:ObjectProperty rdf:about=”mother” />
        <owl:ObjectProperty rdf:about=”child” />
      </xowl:compositeOf>
    </owl:ObjectProperty>
    <owl:ObjectProperty>
      <xowl:compositeOf rdf:parseType=”Collection” >
        <owl:ObjectProperty rdf:about=”father” />
        <owl:ObjectProperty rdf:about=”child” />
      </xowl:compositeOf>
    </owl:ObjectProperty>
  </xowl:intersectionOf>
</owl:ObjectProperty>
```

The unionOf property links a property to a list of property descriptions. A unionOf describes an anonymous property for which any subject and object pair is at least one of the subject and object pair of all property descriptions in the list. The following example describes a property that includes one self, and full and half brothers and sisters.

```
<owl:ObjectProperty>
  <xowl:unionOf rdf:parseType=”Collection” >
    <owl:ObjectProperty>
      <xowl:compositeOf rdf:parseType=”Collection” >
        <owl:ObjectProperty rdf:about=”mother” />
        <owl:ObjectProperty rdf:about=”child” />
      </xowl:compositeOf>
    </owl:ObjectProperty>
    <owl:ObjectProperty>
      <xowl:compositeOf rdf:parseType=”Collection” >
        <owl:ObjectProperty rdf:about=”father” />
        <owl:ObjectProperty rdf:about=”child” />
      </xowl:compositeOf>
    </owl:ObjectProperty>
  </xowl:intersectionOf>
</owl:ObjectProperty>
```

The exceptionOf property links a property to two property descriptions. An exceptionOf describes an anonymous property for which any subject and object pair is subject and object pair of the first property but not the second property. The following example describes a property that is a child but not a son. Usually it is called “daughter”.

```
<owl:ObjectProperty>
  <xowl:exceptionOf rdf:parseType=”Collection” >
    <owl:ObjectProperty rdf:about=”child” />
    <owl:ObjectProperty rdf:about=”son” />
  </xowl:exceptionOf>
</owl:ObjectProperty>
```

The computeValueFrom links the value of a property with a formula. The following example defines a property, given the subject whose value can be computed as the difference between today and the value of the property “dateOfBirth” of the same subject. Usually it is called “age”.

```
<owl:DatatypeProperty>
  <xowl:computeValueFrom>
    <fn:subtract rdf:parseType=“Collection”>
      <xsd:Date rdf:about=“system:today” />
      <xowl:valueOf rdf:resource=“dateOfBirth” />
    </fn:subtract>
  </xowl:computeValueFrom>
</owl:DatatypeProperty>
```

There are three types of Classes: open, restricted, and closed. An instance of an open class can have any properties. For example, an instance of a Person declared under the ontology of FIG. 6(A-D) can have name, sex, and other properties not declared. An instance of a restricted class can only have properties that are declared in the class or in its subclasses. For example, if Person is a restricted class, it can have property sex because it is in one of its subclass Woman. However, it cannot have name as its property because none of its subclass declares name. A subclass of a restricted class must be restricted. A closed class is not allowed to have any subclass. Its instances are not allowed to have any undeclared property.

Contextual System

A context is a way to group rules and terms independent of ontology structure. When an assertion is in a context, it is asserted to be true in that context, but may or may not be true outside the context. An assertion can be in more than one context. For example, let a context date 20050603 represent a context of the date Jun. 03, 2005. An assertion is made that a person JohnWilson's marital status is married. It means that JohnWilson is married in that context. He may or may not be married outside date 20050603.

For any two contexts C and D, if any assertion in context D is also an assertion in C, then C is subcontext of D, and D is supercontext of C. If C and D are subcontext of each other, they are equivalent contexts. For example, date20050603 can be a subcontext of date200506, which represents June 2005. The top context is the universal context. All other contexts are its subcontexts. All assertions not specified in contexts can be viewed as in the universal context.

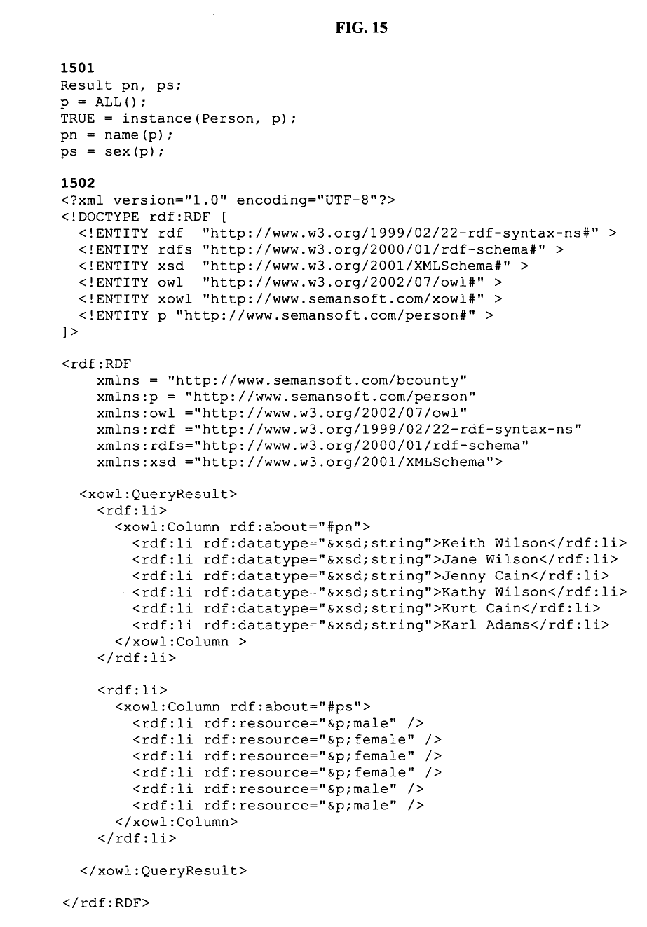

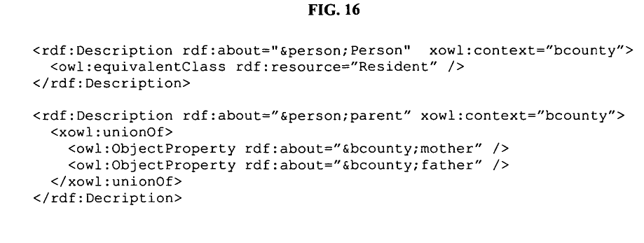

The advantage of context for paraphrasing is to provide additional assertions for the paraphraser to accelerate its operation. For example, in FIG. 7, the paraphraser defines a “Resident” class, which is a subclass of Person in the universal context. In FIG. 16, the paraphraser defines Person as equivalent to “Resident” in bcounty context. A paraphraser, operating in bcounty context, can utilize this assertion and perform better than paraphraser operating in universal context. In FIG. 16, it is also shown that parent can be defined as the union of mother and father in bcounty context. It may not be true in the universal context.

Query Language and Query Canonical Form

There is no restriction on the semantic query language that can be used in the present invention, as long as the corresponding paraphraser can process it. Languages like SPARQL, RQL or ONQL can be used. The preferred embodiment uses a special kind of query language called “the query canonical form, herein referred to as “canonical form”. The canonical form has more expressive power than most semantic query language such as RQL or ONQL. That language can be translated into canonical form more easily, and the corresponding subset of canonical form can be easily translated back to those query languages. Therefore, any algorithm that can work with canonical form can be readily adapted to work with other query languages.

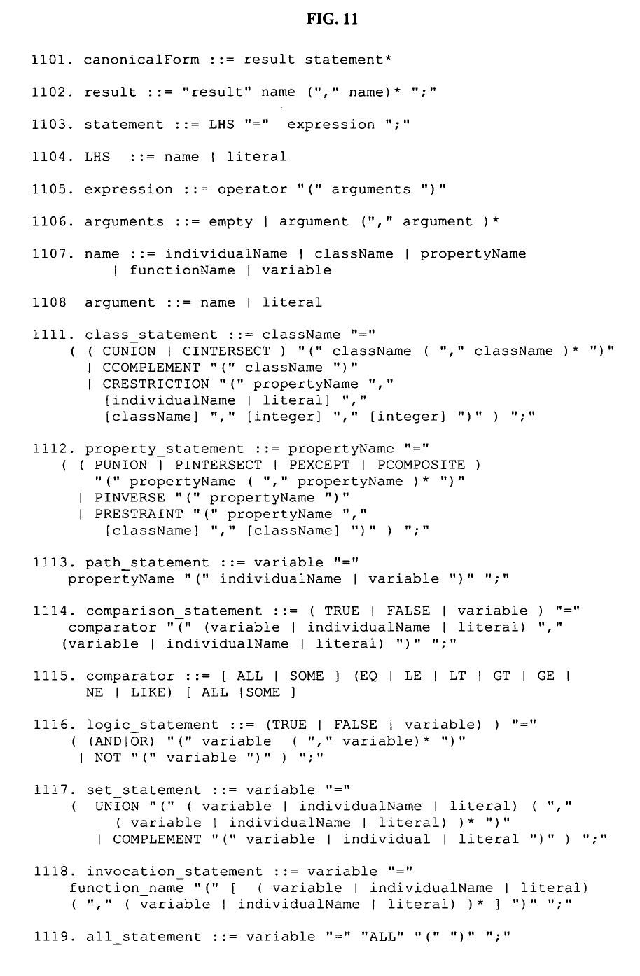

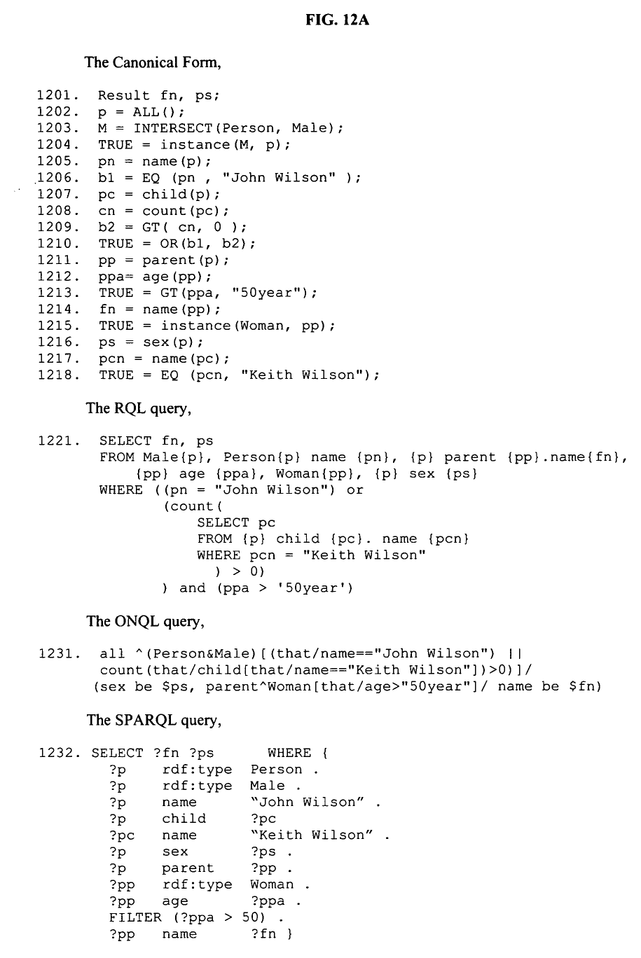

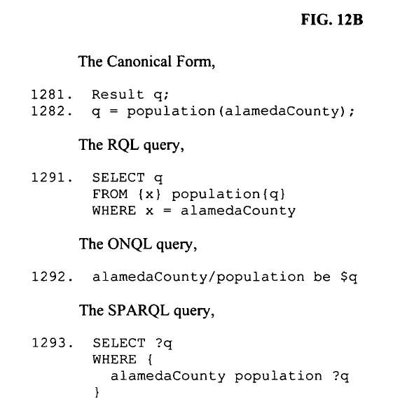

The canonical form can be used as semantic query language directly or serve as an intermediate format for processing. FIG. 11 shows the canonical form. A canonical form, as described in 1101, is comprised of declarations of results, and a collection of statements. 1102-1108 shows the general syntax of a statement. 1111-1119 shows what kinds of statements are allowed and their individual syntax. Basically, a statement consists of an LHS (left-hand-side) and an expression. The LHS can be an individual name, a class name, a property name, a function name, a variable, or a boolean literal. A variable is either a result or just any name that has not been used for other purpose. An expression is always in a function call form. That is, an operator followed by a list of arguments. The operator is never a variable.

A statement is a constant statement if there is no variable in its arguments; otherwise, it is a non-constant statement. Class statements and property statements are always constant statements.

A statement in which the operator is an instance is called an instance statement. It indicates a variable or an individual is an instance of a class or not. For example, the following statement is an instance that indicates p is an instance of Person.

TRUE=instance(Person, p);

The canonical form can always be normalized so for each variable, there can be at most one instance statement. When a variable requires more than one instance statement, it can be expressed a single instance statement whose first argument is a class that is an intersection of the classes that are the first arguments of the original instance statements. Therefore, such requirement places no restriction on the expressive power of the canonical form. For example, if there is another instance statement for p in FIG. 12A.

TRUE = instance(Male, p);

It can be normalized into,

TRUE = instance(MP, p);
MP = CINTERSECT(Person, Male);

A class statement is semantically equivalent to a class declaration in XOWL. A property statement is semantically equivalent to a property declaration is XOWL. A CUNION operator corresponds to unionOf; a CINTERSECT corresponds to intersectionOf, a CCOMPLEMENT statement corresponds to complementOf. A CRESTRICTION operator corresponds to Restriction in OWL. A PUNION operator corresponds to xowl:unionOf, etc.

For example, the following is an intersection statement and its XOWL equivalence.

```
MP = CINTERSECT(Person, Male);
<owl:Class rdf:nodeID=“MP”>
  <owl:intersectionOf>
    <owl:Class rdf:about=“Person” />
    <owl:Class rdf:about=“Male” />
  </owl:intersectionOf>
</owl:Class>
P = PUNION(mother, father);
<owl:ObjectProperty rdf:nodeID=“P”>
  <xowl:unionOf>
    <owl:ObjectProperty rdf:about=“mother” />
    <owl:ObjectProperty rdf:about=“father” />
  </xowl:unionOf>
</owl:ObjectProperty>
C = PINVERSE(parent);
<owl:ObjectProperty rdf:nodeID=“C”>
  <owl:inverseOf rdf:resource=“parent” />
</owl:ObjectProperty>
```

There are 63 comparator operators, some of which are listed in FIG. 11. The notation in FIG. 11 for comparator should be viewed as the concatenation of the modifier, the comparator, and the modifier. For example, ALL EQ SOME should be viewed as ALLEQSOME.

Each statement should be viewed semantically as an equality statement. That is, the left hand side should equal the right hand side. Their order has no semantic significance. A solution to the query means there exist a tuple of values for the results and the local variables that satisfies all statements.

For example, FIG. 12A shows a query of the name of parents, who are older than 50 and are women, and sex, of all male persons named “John Wilson”, or who has at least one child in its canonical form, its SPARQL form, RQL form, and ONQL form. The statements 1201-1218 show the query in the canonical form. Statement 1201 states the query has two results fn and ps. Statement 1202 states that p can be any individual. Statement 1203 is a class statement that states that M is an intersection of Person and Male. Statement 1204 is an instance statement that states the variable p is an instance of M. Statement 1205 states p's name is pn. Statement 1206 states b1 is the result of the expression pn equals “John Wilson”. Statement 1207 states pc is p's child. Statement 1208 states cn is the number of pc. Statement 1209 states that b2 is the result of comparison that cn is greater than 0. 1210 states either b1 or b2 must be true. Statement 1211 states pp is p's parent. Statement 1212 states ppa is the age of pp. Statement 1213 states ppa must be greater than 50 years. Statement 1214 states fn is pp's name. Statement 1215 states pp is an instance of Woman. Statement 1216 states p's sex is ps. Statement 1217 states pc's name is pcn. Statement 1218 states pcn equals “Keith Wilson”.

FIG. 12B shows a query for the population of an individual in the target data system. It specifies the individual to be alamedaCounty.

Statements may use one another. A statement R is a parent of another statement S if the R's LHS is a name and it occurs inside the expression of S. For example, in FIG. 12A, statement 1211 is a parent of statement 1212. The inverse of parent is child. The transitive closure of parent is ancestor. The transitive closure of child is descendent. Statement 1212 in FIG. 12A is a descendent of 1211. A statement that has no ancestor is a top statement. Statement 1202 in FIG. 12 is a top statement. A statement that has no descendent is a bottom statement. Statements 1216, 1214, 1210, and 1218 are bottom statements.

Through ancestral relation, statements form a “use graph.” A valid query in canonical form should always be unique, complete, and acyclic. That is, a variable should appear as LHS exactly once, and no statement should be an ancestor of itself.

Acceptability and Reachability of a Property

The purpose of query is to retrieve data from a data system. If it can be determined beforehand that a property whose value is to be queried does not exist in the target system, it is not necessary to query. Acceptability and reachability helps to determine the existence of a property.

A property p is acceptable to a class if it is possible to have an instance of that class with p. A property p is acceptable to an individual or a variable if it is acceptable to its class. For example, sex is acceptable to Resident because one of its subclass is a restriction on sex.

A property is reachable in a data system if there exists a path from the queriable classes or the target to reach that property. For example, alamedaCounty is the target. The property population is reachable because it can be reached through the path, alamedaCounty/county/population. In addition, if caDMV is the target, the property sex is reachable through the path Resident/sex, where Resident is a queriable class of canDMV.

Class and Property Expression

A class expression is an expression consisting of union, intersection, and complement operations on classes. If a class cannot be defined with a class expression, it is a primitive class. A class not defined with other classes, a restriction, or an enumerated class is a primitive class. A class expression is completely unfolded if all classes in the expression are primitive classes. A class expression is normalized if no union operation is contained inside an intersection operation, and complement operations are only on primitive classes. A class expression is optimized if no single argument union, or intersection, and no class in a union that is a subclass of the union of the rest of classes, no class in an intersection is an intersection is a subclass of another class. For example, the expression

intersect(a, complement(union(b, c)))

is not normalized, while the following expression is . . .

union(intersect(a, b), intersect(c, complement(d)))

A property expression is an expression consisting of property union, property intersection, property composition, property restraint, property function invocation, property inversion, and property same as operators. If a property cannot be defined with a property expression, it is a primitive property.

Dictionary 315 Operations

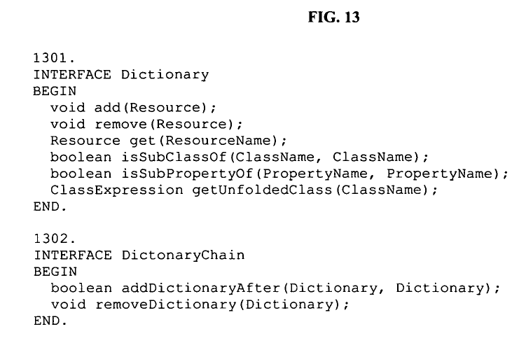

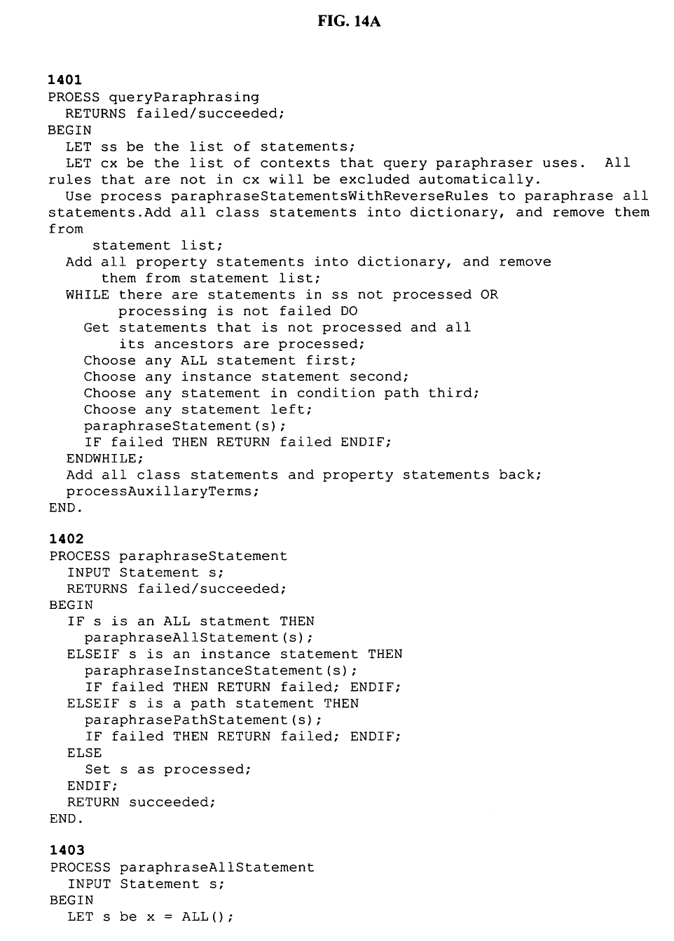

A dictionary is a system that holds information on ontology and provides services to add, remove, and answer questions about ontology. The basic interface of a dictionary is shown in FIG. 13. Here, following RDF, a resource can be classes, properties, and individuals. Most of them are easy to implement and persons with ordinary skill in the semantic field should be able to implement them.

The add operation adds a resource into the dictionary. A more elaborate dictionary can have an add operation to add all resources in an ontology in a single operation. It can also include a parser to add all resources in an XOWL document.

The remove operation removes a resource from the dictionary. A more elaborate dictionary can remove resources in an ontology in one operation. It may also setup a transaction during the add, then remove all resources since that transaction point.

The get operation retrieves a resource's declaration given the resource name.

The isSubClassOf operation checks whether the first class is a subclass of the second class. There are many existing algorithms, such as tableaux algorithm and its variations, which can verify subsumption between two classes.

The isSubPropertyOf operation checks whether the first property is a subproperty of the second property. A structure search along the subPropertyOf relation graph either from the first property up or the second property down, or use a variation of tableaux algorithm can verify the subsumption between two properties.

The getUnfoldedClass operation returns the optimized, unfolded class in a class expression. The following is an example. Student is a subclass of Person. Brackets are used to express restriction on property.

Let a class A be defined as,

intersect( union(Person, Female),
complement(intersect(Man, Student)))

After unfolding, it becomes

```
union(
  intersect(Person, complement(Person)),
intersect(Person, complement(Restriction(sex,male,,1,1)) ),
intersect(Restriction(sex,female,,1,1), complement(Person)),
intersect(Restriction(sex,female,,1,1),
      complement(Restriction(sex,male,,1,1)) ),
intersect(Person, complement(Student)),
intersect(complement(Restriction(sex,male,,1,1)),
      complement(Student)) )
```

After optimization, it becomes

union( intersect(Person, complement(Student)),
complement(Restriction(sex,female,,1,1)) )

Dictionaries can be chained together. A dictionary chain is a sequence of dictionary linked together one after another. When a term is not found in one dictionary, it is automatically sent to the next dictionary down the chain. If any of the dictionaries finds the answer, it is propagated through the chain back to the first dictionary. When dictionaries are in the chain, each individual dictionary can still be accessed directly. Operations can be set to control whether it should be propagated along the chain or not. Statement 1302 defines operations for dictionary chain. The operation addDictionaryAfter adds the first dictionary after the second dictionary. If the second dictionary is null, it adds to the front of the chain. The operation removeDictionary removes a dictionary from the chain.

In the preferred embodiment, the target dictionary is chained before the source dictionary as shown in FIG. 9A. Furthermore, if necessary a temporary dictionary is chained between the target dictionary and source dictionary to hold temporary ontology of the current query.

The class of the target itself must provide a way to enumerate all classes that it accepts for a query based on class. In the preferred embodiment, the queriableclass property has all classes that can be queried. FIG. 7 shows that the queriableClass of the alamedaCounty has value Resident. The queriableclass of caDMV has value Resident, and RegisteredVehicle. It is preferable that a queriable class not be union. It is easier for data system to handle.

Auxiliary Dictionary

If a term in source ontology but not in target ontology can be defined with semantically equivalent expressions of terms in target ontology, the term and its rule is put into the auxiliary dictionary. They are called auxiliary terms. In FIG. 16, both Person and parent are put in the auxiliary dictionary. Furthermore, all terms in source ontology that can be defined with semantically equivalent expressions of terms in target ontology and/or auxiliary terms should be placed into target dictionary but marked as auxiliary terms. They become a part of target ontology for the duration of query paraphrasing. For example, grandparent can be defined as parent's parent. Since parent is in auxiliary dictionary, grandparent should be placed into auxiliary dictionary too. It is said that grandparent derived from parent.

Query Paraphrasing Process Overview

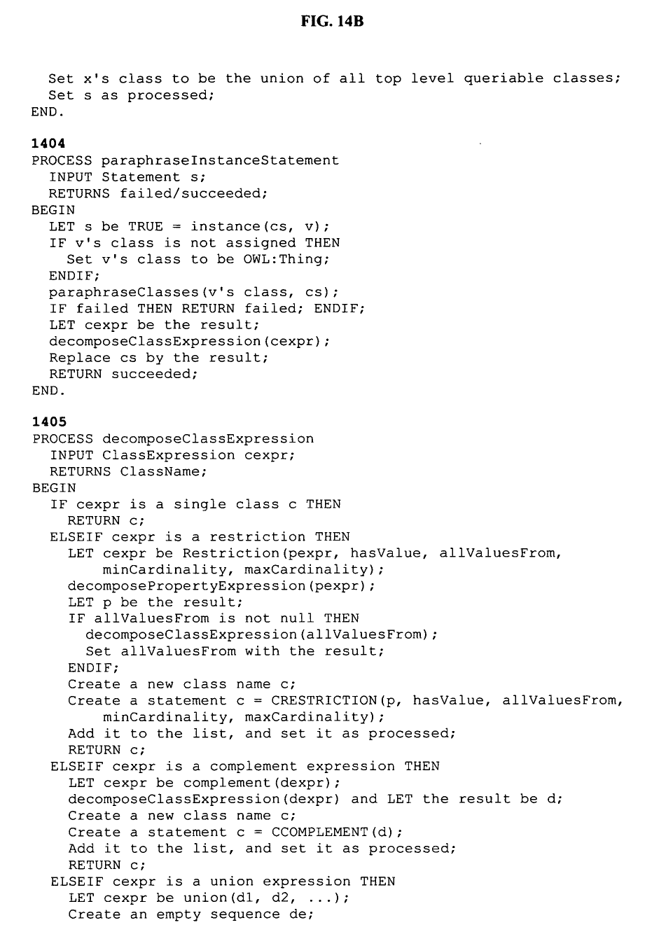

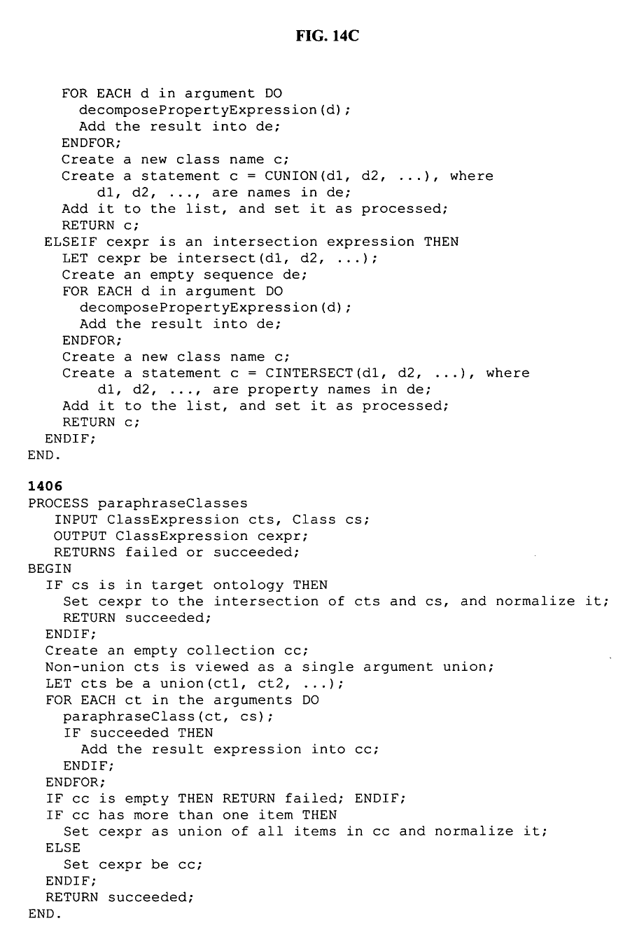

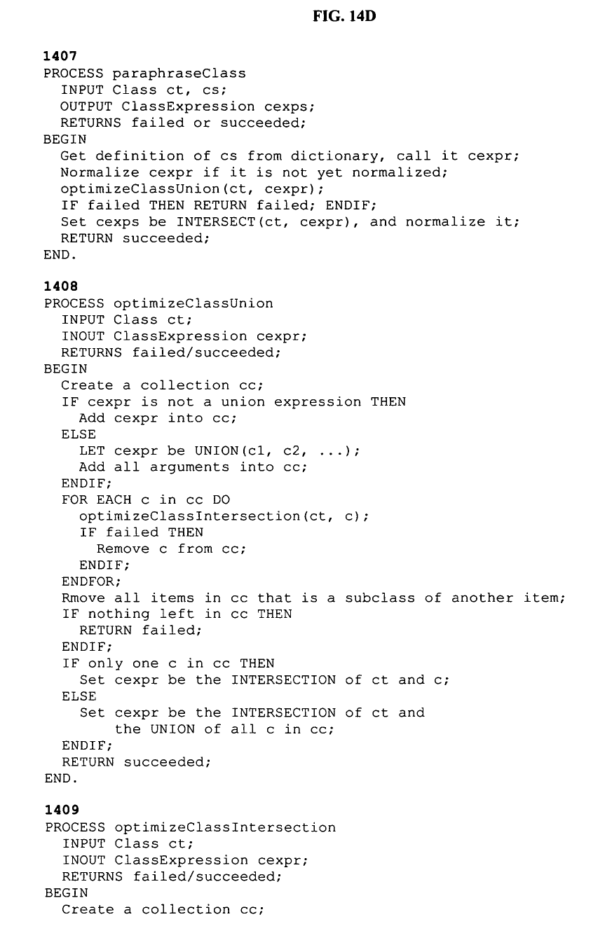

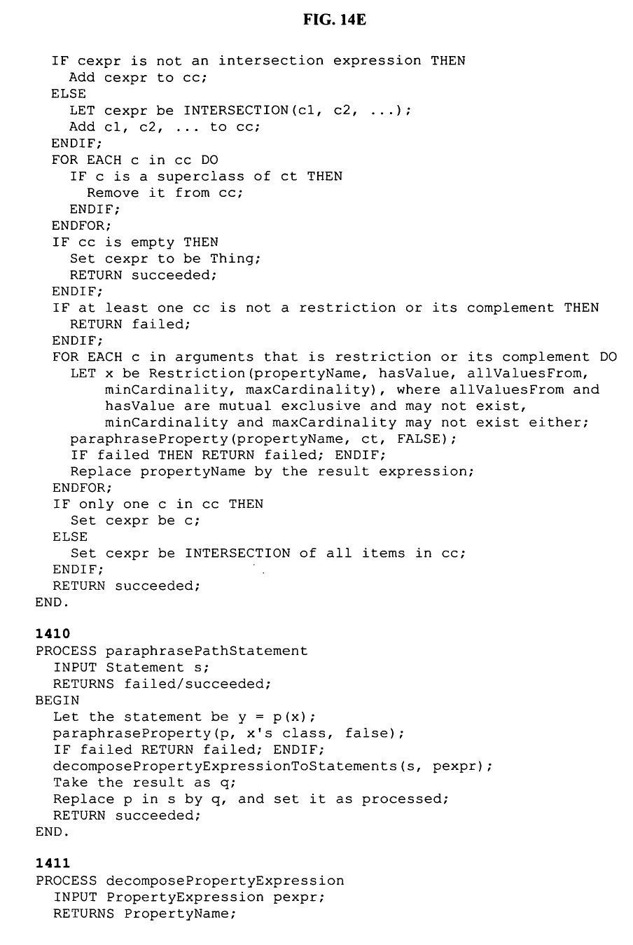

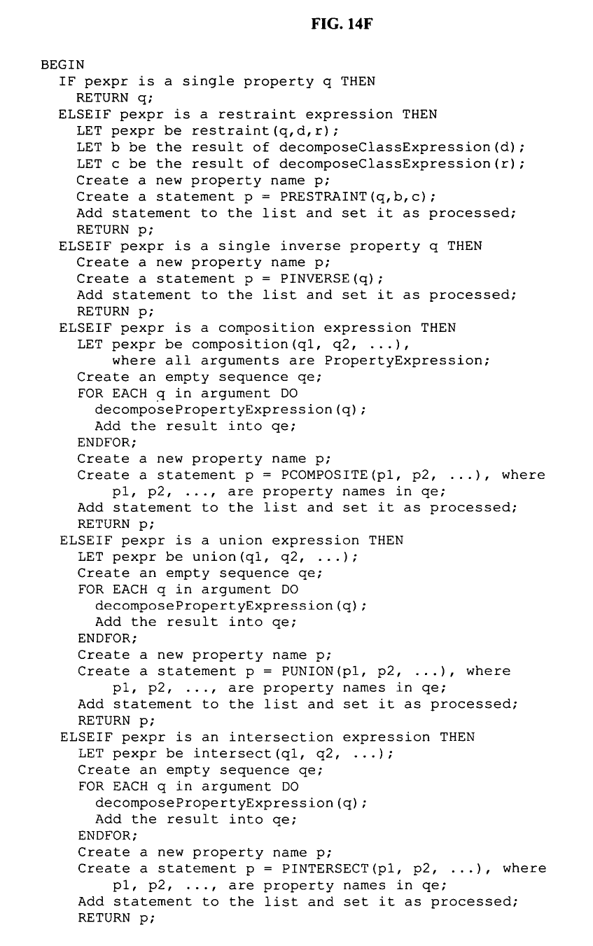

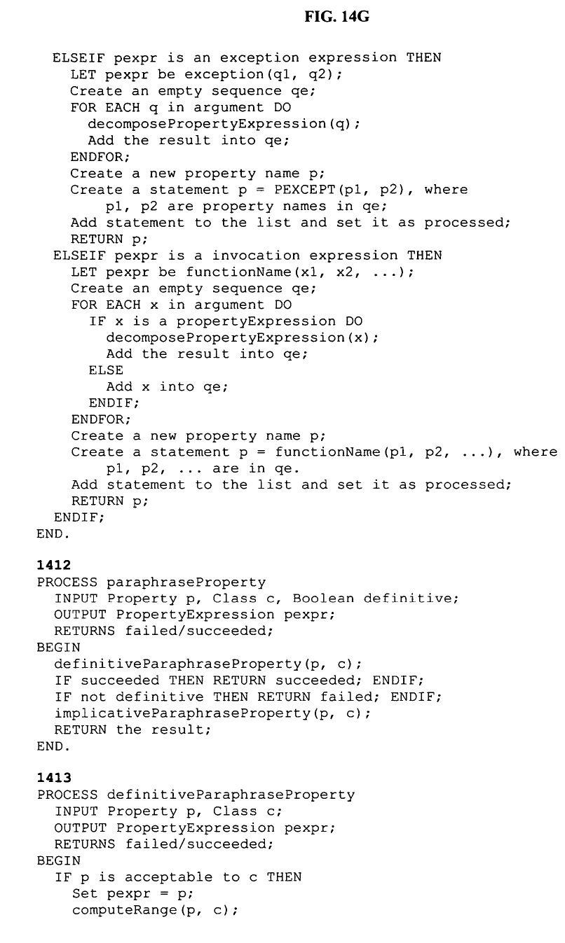

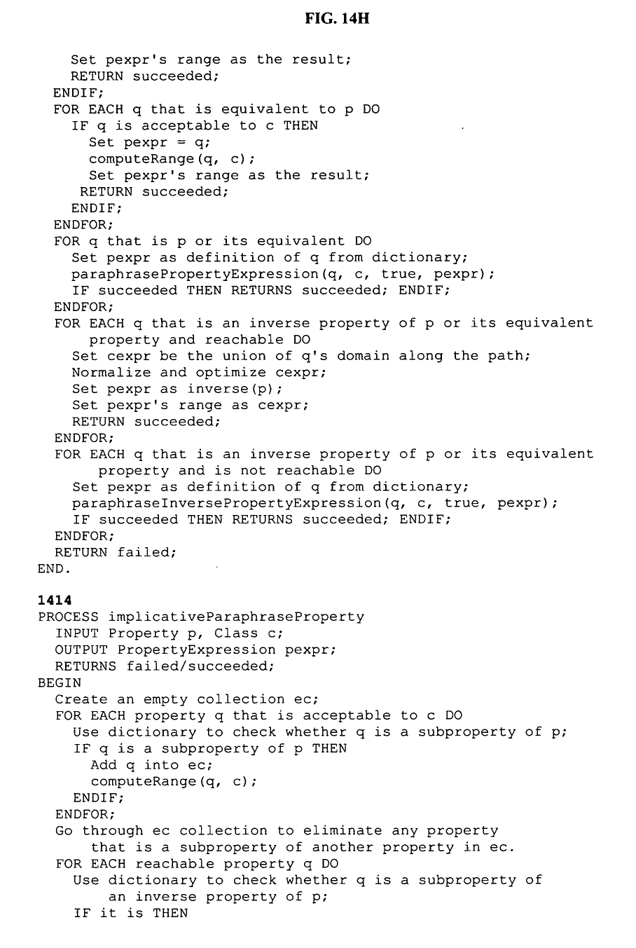

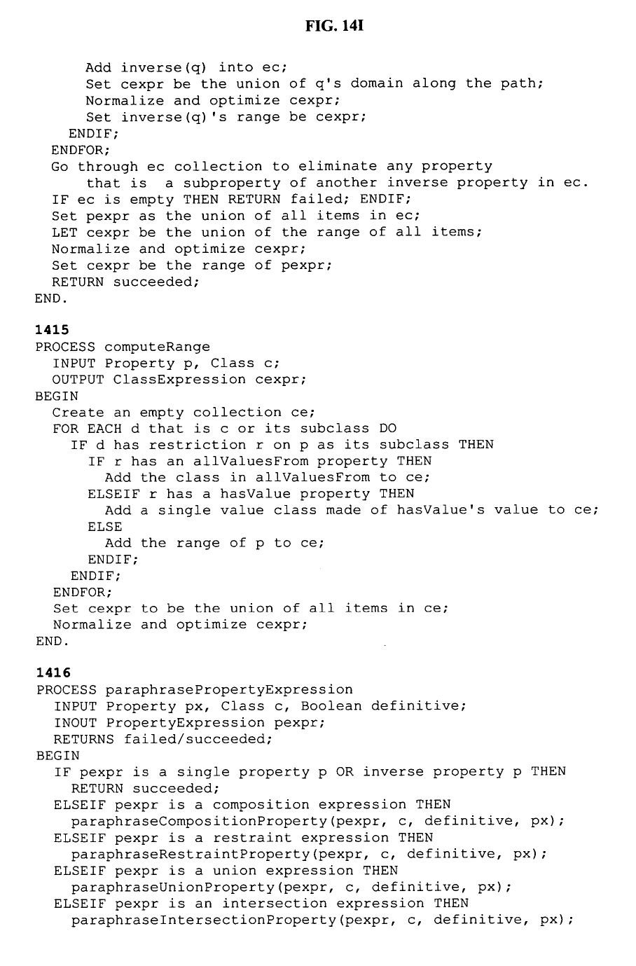

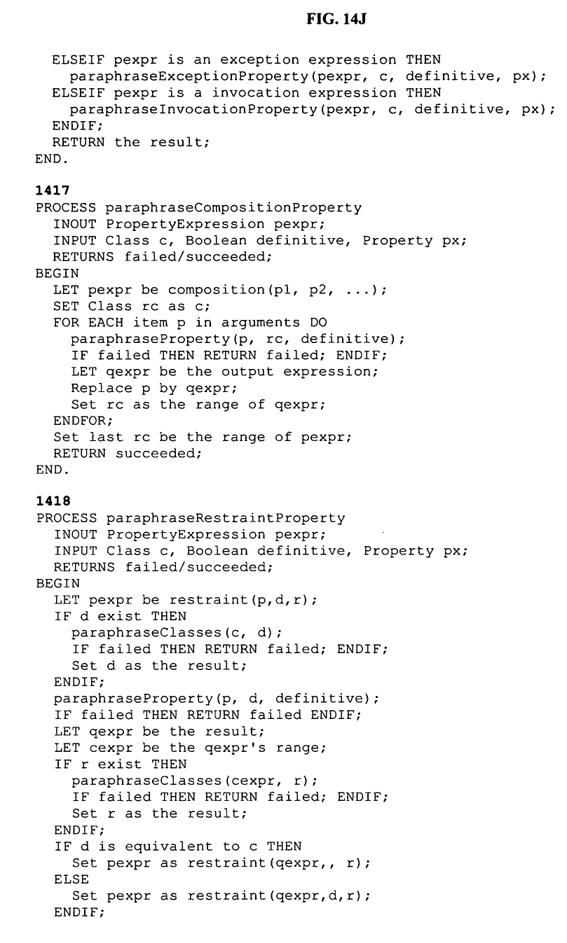

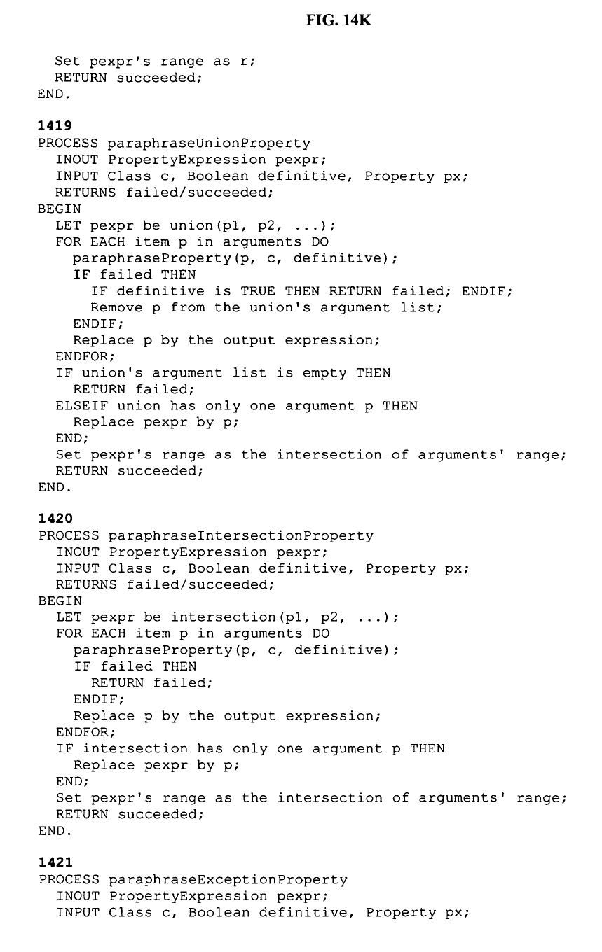

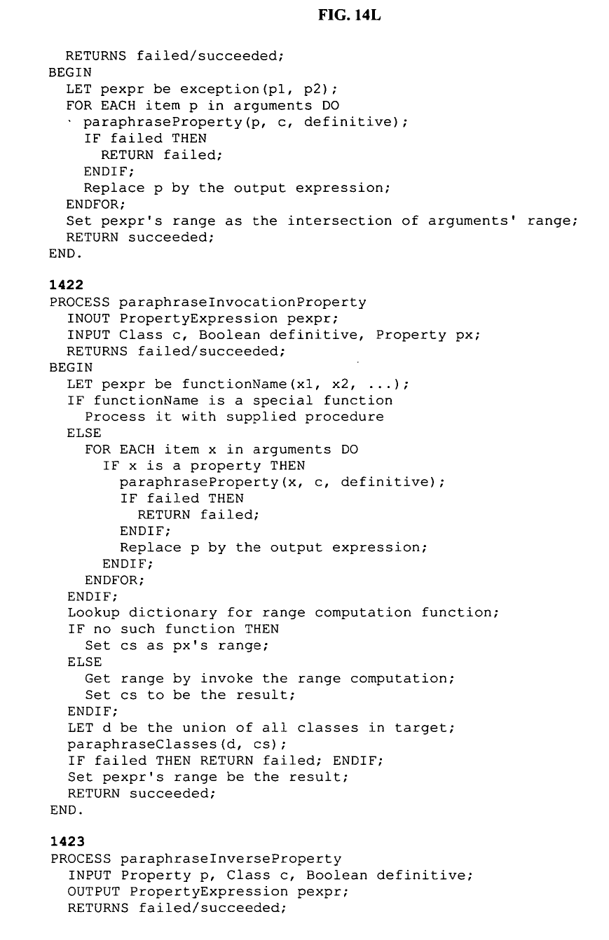

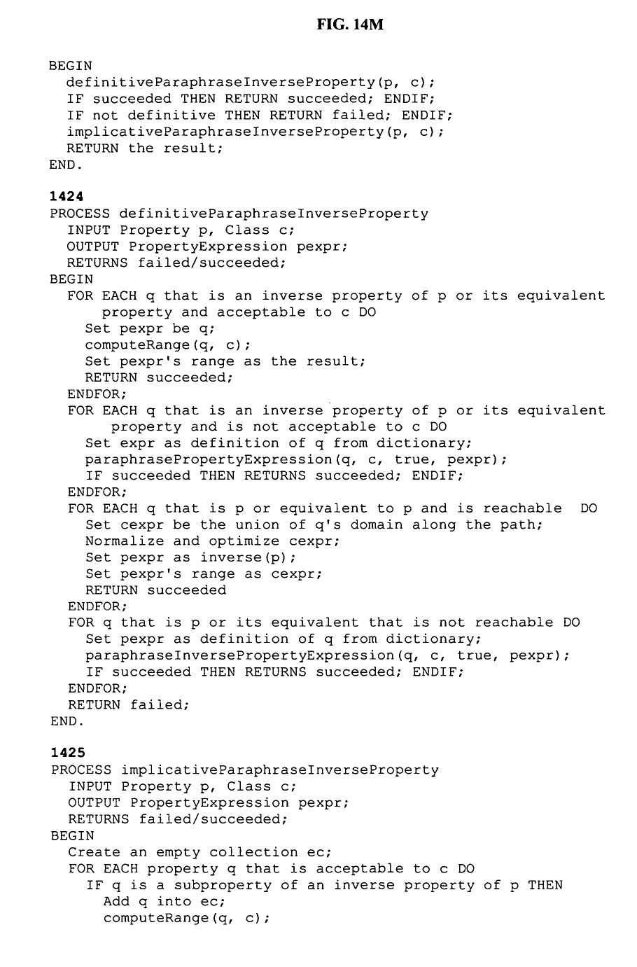

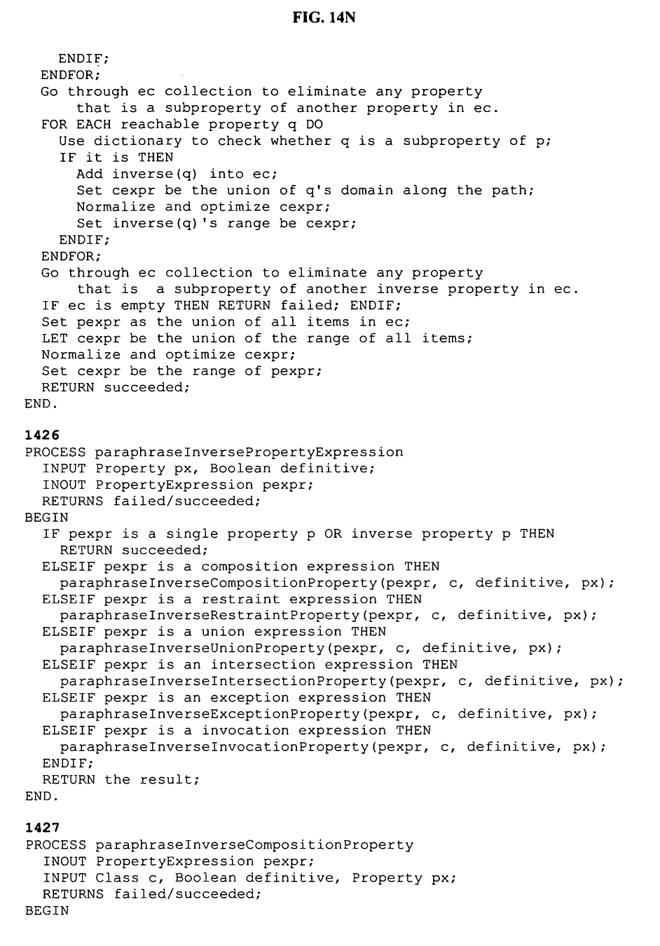

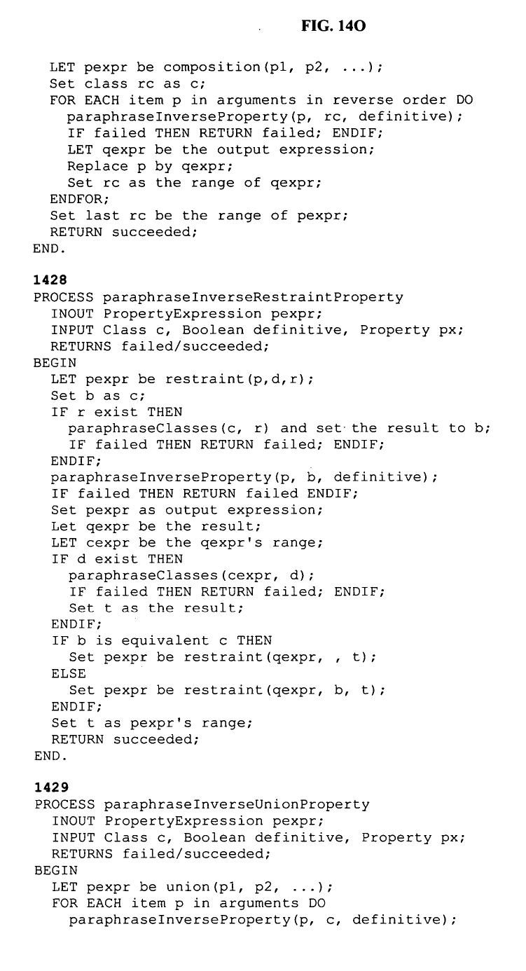

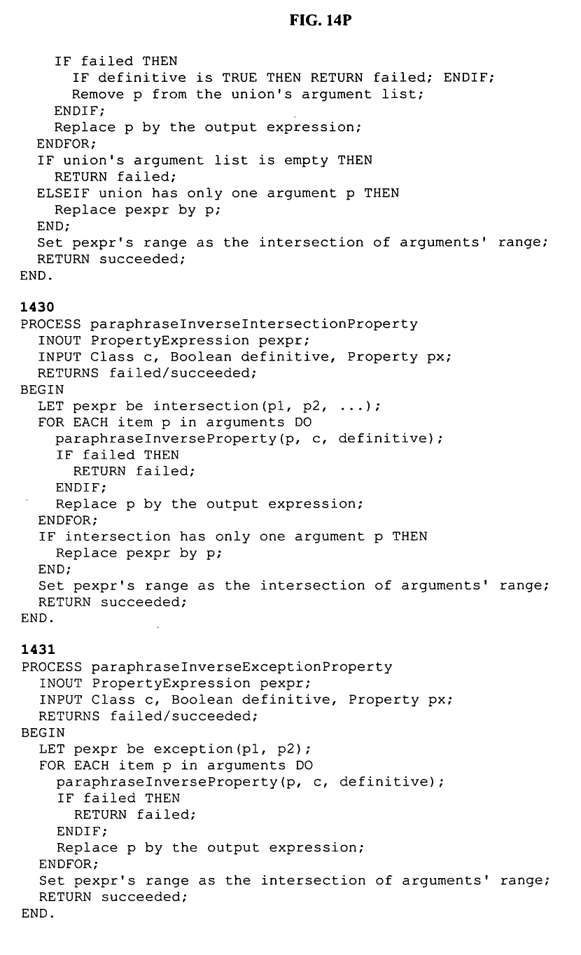

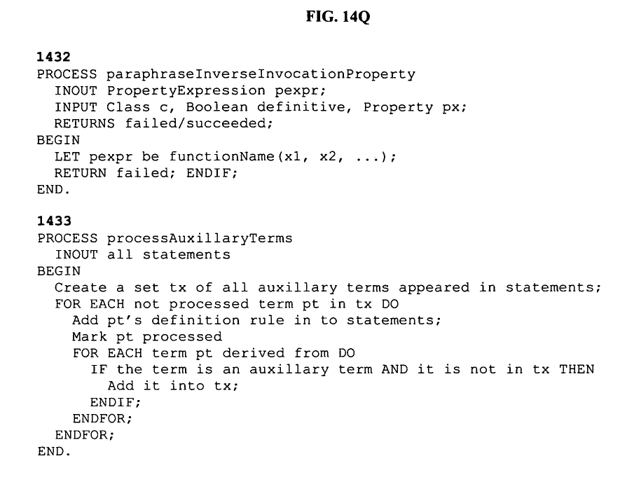

The core of the query paraphrasing process is to paraphrase a query in canonical form from one ontology to another ontology by applying semantically equivalent rules or semantically implicative rules. Though statements can be processed in any order, certain order will be more efficient. The process is described in terms of canonical form in FIG. 14 (A-Q).

Although the process is described in terms of canonical form, it should be apparent that a query language does not have to be completely decomposed into the canonical form to use portions of the process or the whole process itself.

To illustrate how the process works, it is necessary to define certain terminology. In the canonical form, a statement, whose LHS is a result variable, is a result statement. Both 1214 and 1216 are result statements. A statement is in result path, if it is a result statement, or an ancestor of a result statement. 1202, 1211, 1214, and 1216 are in result path. Any statement that is not in result path is in condition path. 1203, 1204, 1205, 1206, 1207, 1208, 1209, 1210, 1212, 1213, 1215, 1217, and 1218 are all in condition path.

A bottom statement in condition path is a condition root. 1204, 1210, 1213, 1215, and 1218 are condition roots. Among them, 1204 and 1215 are also instance statements. A condition root's all ancestors in condition path together with the root forms a condition graph. For example, 1212, and 1213 are in the same condition graph with 1213 as its root. A condition root's all ancestors in result tree are the triggering statements of the graph. 1202 and 1211 are triggering statements of the condition graph with 1213 as its root.

A class is queriable within a target class if it appears in the value of queriableclass of the target class. A queriable class that is not a subclass of any other queriable class is a top-level queriable class. In a virtual data system, all classes in the target ontology are queriable classes.

In all processes, the current list of statements and dictionaries are readily accessible. To illustrate the processes, FIG. 12 examples are used. The target system is alamedaCounty.

The guiding principles of the process are as follows:
1. It is always preferable to apply a semantically equivalent rule than semantically implicative rule.
2. A statement is eligible for processing if all its ancestors are processed, or it has no ancestor.
3. When there are many semantically implicative rules that do not imply each other, try to use union of them. For example, the rules “Woman is a subclass of Person” and “Man is a subclass of Person” do not imply each other. When applying rules to paraphrase “Person”, choose the union of “Woman” and “Man”. Similarly, “husband is a subproperty of spouse”, so is “wife”. To replace “spouse”, it is preferable to use the union of “husband” and “wife”.
4. An inverse property paraphrasing is semantically equivalent. For example, parent and child are inverse properties. The statement “x is y's parent” is semantically equivalent to “y is x's child”.
5. It is always preferable to process a statement's ancestor earlier. Therefore, top statements should be processed first.
6. For all eligible statements, it is preferable to process ALL statements first, instance statements second, other statements in condition path third, and the rest last.
7. Property expressions and class expressions should be treated as definitions of new properties and classes, and processed before other kinds of statements.
8. Using acceptability to check whether a property should be further paraphrased.
9. Using reachability to check whether an inverse property should be further paraphrased.

Detailed Description of Query Paraphrasing Process

In the following explanation, the example in FIG. 12A is used as much as possible and the target system is caDMV defined in FIG. 7 (A-D). In the description of the processes, the list of statements in the query, and dictionaries are accessible by all processes. The processes can easily be modified to pass them as parameters.

The Overall Ouery Paraphrasing Process

Referring back to the process of query paraphrasing for the canonical form in FIG. 14 (A-Q), PROCESS 1401 is the overall query process. It first places all class statements into the dictionary. In preferred embodiment, a temporary dictionary is created to store those temporary declarations. It forms a chain with the target dictionary and the source dictionary. In FIG. 12A, 1203 causes a new class M to be added into the dictionary. Then it adds all property statements into the dictionary. For example, if there is a property statement:

parent=PUNION(mother, father);

It is added into dictionary. Both class statements and property statements are removed from query statement list. When they are added into the dictionary, the class name and property name on the left-hand-side becomes a part of the target ontology during the query paraphrasing.

The remaining statements are processed one by one until either the processing is failed or all of them are processed. As described in guiding principle 4 (above), a statement is eligible for processing only after its ancestors are processed. Furthermore, ALL in the result path should be processed first. Hence, statement 1202 is selected. Afterwards, statement 1204 is chosen because it is an instance statement. Then 1205 or 1207. For illustration purpose, let us always choose the statement of lower number. After 1205, and 1206, then 1207, 1208, 1209, 1210, 1217, 1218, following by 1211, 1215, 1212, 1213, 1214, 1216. In example FIG. 12B, there is no ALL statement. Statement 1282 is to be processed first.

PROCESS 1405 is a dispatcher that invokes different processes according to statement types. For those types of statement that does not require further processing, it is simply marked as processed.

PROCESS 1403 is to process ALL statement. It simply creates a union of all top-level queriable classes and sets it as the class of the variable. Top queriable classes are queriable classes that are not subclass of other queriable classes. For example, statement 1202 will cause p's class be union(Resident, Vehicle).

An Operation to Paraphrase Instance Statement

PROCESS 1413 is to process instance statement. It first checks whether the class is already in the target ontology. If it is, it intersects with variable's current class, and then optimizes the result. For example, if the statement is

TRUE = instance(Resident, p);

and the class of p is union(Resident, RegisteredVehicle). The result will be Resident. The class of p will be set to Resident. Now take 1204 as an example. Its class is defined in 1203, and not in target ontology. As described above, the class of the variable p is union(Resident, Vehicle). It is processed with PROCESS 1406. The resulting expression is decomposed with PROCESS 1405 into statements in canonical form.

An Operation to Decompose Class Expression into Statements

PROCESS 1405 decomposes a class expression into statements. For example, to decompose the expression

union(RegisteredVehicle,
intersect(Resident, Restriction(sex,male,,1,1)))

The first step is to decompose each section of the union. RegisteredVehicle is decomposed to itself. The second argument is an intersection. Each section is decomposed separately. Resident is decomposed to itself. The restriction is decomposed into a statement,

x1 = CRESTRICTION(sex,male,,1,1);

The intersection is now becomes

x2 = CINTERSECT(Resident, x1);

The union is now becomes

x3 = CUNION(RegisteredVehicle, x2);

An Operation to Paraphrase Class Expressions

PROCESS 1406 paraphrases the intersection of a normalized class expression named cts, and a class named cs into a new class expression in target ontology. cts must be in target ontology already. Therefore, if cs is also in target ontology, there is no need to paraphrase. If it is not, cts is treated as a union expression. Each section is processed with PROCESS 1407. For example, let cts be union(Resident, RegisteredVehicle) and cs is intersect(Person, Male). PROCESS 1407 is invoked to process intersection of Resident and cs. The result will be intersect (Resident, Restriction (sex,male,,1,1)). Then PROCESS 1407 will be invoked to process the intersection of RegisterVehicle and cs, the result will be failed. Hence the final result in PROCESS 1406 is intersect(Resident, Restriction(sex,male,1,1)).

PROCESS 1407 is to paraphrase the intersection of two classes, ct and cs. The class ct is always in target ontology, while cs may not. If the paraphrasing process is successful, it outputs a normalized class expression. The process first gets the definition of cs, then normalizes it, then creates an expression by intersecting it with ct. Finally, it processes the result by invoking the optimizeClassUnion. For example, let ct be Resident, and Cs be M. First, it obtains the definition of M, which is intersect(Person, Male). After normalization, it becomes intersect(Person, Restriction(sex,male,1,1)). After PROCESS 1408, the result is Restriction(sex,male,1,1). Now ct is intersected with the result and the final expression becomes intersect(Resident, Restriction(sex,male,, 1,1)).

PROCESS 1408 is to paraphrase an intersection of a class and a class expression, which is a union. It first checks whether the expression is a union or not. If it is not a union, it is simply treated as a single argument union. For each section in union, PROCESS 1408 invokes the optimizeClasslntersection to process it. If any processing is a failure, it removes that section. Then it uses the results to form a union expression if there is more than one result. For example, intersect(Person, Restriction(sex,male,1,1)) is not union. It is passed to optimizeClasslntersection. The resulting expression is Restriction(sex,male,1,1). Since there is no other section in the union, it is the result of this process.

PROCESS 1409 is to paraphrase a class expression that is an intersection. It first checks whether the expression is an intersection or not. If it is not, the process treats it as a single argument intersection. For example, let ct be Resident and the expression be intersect(Person, Restriction(sex,male,1,1)). It first removes all superclass of ct from the intersection. Next, since Person is a superclass of Resident, it is removed. The resulting expression is Restriction(sex,male,1,1). The property of a restriction must be paraphrased too. It is done by invoking the paraphraseProperty process. Here, sex is the property. Since it is in target ontology, the result after paraphraseProperty is itself. So the resulting expression is Restriction(sex,male,1,1).

An Operation to Paraphrase Path Statement

PROCESS 1410 is to paraphrase a path statement. A path statement is in the form of y=p(x), where p is a property. It means that x represents the value of y's property p. The primary work is to paraphrase p in source ontology to an expression of properties in target ontology. The actual paraphrasing is performed by PROCESS 1412. After the expression is created, it is decomposed into canonical form by the PROCESS 1411 (see below).

An Operation to Decompose Property Expression into Statements

PROCESS 1411 is the process to decompose an property expression into canonical form. For example, the property expression

```
union(
  restraint(
    parent,, intersect(Resident, Restriction(sex,male,,1,1) ) ),
  restraint(
    parent,, intersect(Resident, Restriction(sex,female,,1,1))) )
```

is decomposed into

p1 = PUNION(p2, p3);
p2 = PRESTRAINT(parent,, c2);
p3 = PRESTRAINT(parent,, c3);
c2 = CINTERSECT(Resident, c4);
c4 = CRESTRICTION(sex,male,,1,1);
c3 = CINTERSECT(Resident, c5);
c5 = CRESTRICTION(sex, female,,1,1);

An Operation to Paraphrase Property

PROCESS 1412 is the process to paraphrase a property into a property expression. Following the guiding priniciple 1, the semantically equivalent property expression should be tried first. Only when it is not possible to have semantically equivalent paraphrasing, semantically implicative paraphrasing is used.

Whether a property requires paraphrasing depends on whether it is acceptable to the class of the variable. A property p is acceptable to a class if it is possible to have an instance of that class with p. A property p is acceptable to a variable if it is acceptable to its class. For example, sex is acceptable to Resident because one of its subclass is a restriction on sex.

Whether an inverse property can be used depends on the concept of reachability. That is, whether there exists a path from the queriable classes or the target to reach that property. For example, alamedaCounty is the target. It has a path to population. The path is alamedaCounty/county/population. In addition, if caDMV is the target, it has a path to sex. The path is Resident/sex because Resident is a queriable class of caDMV.

PROCESS 1413 is the process that produces the semantic equivalent expression of a property p with owner class c. It first checks whether p is acceptable to the class c. If it is, no need to process. If it is not, it searches all equivalent class to see whether any of them is acceptable to c. If none is found, it looks up the definitions of p or its equivalent classes. If any one of them can be paraphrased, then use it. If none of them can be used, try the inverse property. It first checks whither an inverse property of p is reachable. If it is reachable, it is found.

For example, sex is an acceptable property to Resident, it requires no paraphrasing. The property grandparent is not an acceptable property to Resident, its definition composite(parent,parent) is used for further paraphrasing. The property child is not an acceptable property. It does not have any equivalent property that is acceptable. It also does not have definition. Its inverse property parent is not reachable. For this example, let us assume parent is defined as union(mother, father) in the dictionary. The paraphraselnversePropertyExpression is invoked for processing. The result is union(inverse(mother), inverse(father)).

PROCESS 1414 is the process that accepts a property p and its owner class c, and produces a semantic implicative expression. It takes all subproperties of p that is acceptable to c, and inverses of all reachable subproperties of inverse properties of p, and forms a union. It optimizes the union by eliminates all properties that are subproperties in the union. For example, let c be Resident and let p be child. There is no subproperty of child that is acceptable to Resident. There are mother and father that are subproperties of parent, which is an inverse property of child. Therefore, the result is a union(inverse(mother), inverse(father)).

PROCESS 1415 computes the range of a property p given an owner class c. It goes through all subclasses of c and itself to find any restriction on p. The range of p is their union. For example, if the class is Resident and the property is mother. The original mother's range is Woman, but in Resident, mother's allValuesFrom is FemaleResident. Hence, FemaleResident is chosen as the range of mother.

PROCESS 1416 is a process that dispatches the property expression to different processes for paraphrasing.

PROCESS 1417 paraphrases a composition property expression. For example, if the expression is

composition(husband, mother)

First husband, then mother are processed one by one by invoking paraphraseproperty. The husband is replaced by the result restraint(spouse,,Man). Man is further paraphrased. The mother is not changed. The resulting expression is

```
composition(
  restraint(spouse,,
          intersect(Resident, Restriction(sex,male,,1,1)),
mother))
```

PROCESS 1418 paraphrases a restraint property expression. It first paraphrases the property, and then invokes paraphraseClasses process to paraphrase the range. For example, the restraint

restraint(spouse,, Man)

Is paraphrased into

restraint(spouse,,
intersect(Resident, Restriction(sex, male,,1,1)))

PROCESS 1419 paraphrases a union property expression. It paraphrases all arguments in the union and removes all failed one if it is not definitive. For example, the expression

union(husband, wife)

is paraphrased into

```
union(restraint(spouse,,
    intersect(Resident, Restriction(sex, male,,1,1))),
  restraint(spouse,,
    intersect(Resident, Restriction(sex,female,,1,1))))
```

PROCESS 1420 paraphrases an intersection property expression. It paraphrases all arguments in the intersection. For example,

intersect(spouse, husband)

is paraphrased into

```
intersect(spouse,
    restraint(spouse,,
      intersect(Resident, Restriction(sex,female,,1,1))))
```

PROCESS 1421 paraphrases an exception property expression. It paraphrases both arguments in the exception. For example,

except(spouse, husband)

is paraphrased into

```
except(spouse,
    restraint(spouse,,
      intersect(Resident, Restriction(sex,female,,1,1))))
```

PROCESS 1422 paraphrases an invocation property expression. If the function is a special function that has supplied processing procedures, that procedure is used to process the expression. Otherwise it paraphrases all arguments that are properties. For example,

subtract(today, age)

subtract(today, subtract(today, dateOfBirth))

PROCESS 1423 paraphrases an inverse property. It accepts an inverse property p, a class c, and whether only equivalent paraphrasing is allowed. It first invokes the definitiveParaphraselnverseProperty to process the property. If it failed and implicative paraphrasing is allowed, it invokes the implicativeParaphraselnverseProperty.

PROCESS 1424 is the process that produces the semantic equivalent expression of an inverse property p with owner class c. It tries whether any non-inverse property will work or not, before it tries the inverse properties. Therefore, it first checks whether any inverse property of p is acceptable to c. If none is found, then it looks up definitions of its inverse properties to see anyone can be paraphrased. If not, it checks p itself and all its equivalent properties to see anyone of them is reachable. If none is found, it looks up dictionary for their definitions and invokes paraphraselnversePropertyExpression to process them. For example, let child be p and Resident be c. The inverse of child is parent, which is not acceptable. Let assume parent is defined as union(mother, father). The process paraphrasePropertyExpression is invoked to process it. Because mother and father are acceptable to Resident, the result is union(mother, father). For another example, let parent be p and Resident be c. The inverse of parent is child, which is not acceptable. The term child has no equivalent property nor definition. Hence parent's equivalent property is used, which is union(mother, father). The process paraphraselnverPropertyExpression is invoked. The result is union(inverse(mother), inverse(father)) since both mother and father are reachable.

PROCESS 1425 is the process that accepts an inverse property p and its owner class c, and produces a semantic implicative expression. It takes all subproperties of inverse p that is acceptable to c, and all subproperties of p, to form a union. It optimizes the union by eliminates all properties that are subproperties in the union. For example, let c be Resident and let p be parent. The inverse property of parent is child. There is no subproperty of child that is acceptable to Resident. There are mother and father that are subproperties of parent, which is an inverse property of child. Therefore, the result is a union(inverse(mother), inverse(father)).

PROCESS 1426 is a process that dispatches the inverse property expression to different processes for paraphrasing.

PROCESS 1427 paraphrases an inverse composition property expression. For example, if the expression is

inverse(composition(husband, mother))

After distributing the inverse operator into the composition, it becomes

composition(inverse(mother), inverse(husband))

First, inverse(mother), then inverse(husband) are processed one after another by invoking the paraphraselnverseProperty process. The expression, inverse(mother) is not changed. The inverse(husband) is wife, and is paraphrased into restraint(spouse,,Woman). The resulting expression is

union(inverse(husband), inverse(wife))

is paraphrased into

```
union(restraint(spouse,
    intersect(Resident, Restriction(sex,male,,1,1)), ),
  restraint(spouse,
    intersect(Resident, Restriction(sex,female,,1,1)), ))
```

PROCESS 1430 paraphrases an intersection property expression. It first distributes the inverse operator to each argument, and then paraphrases all arguments in the intersection. For example,

inverse(intersect(spouse, wife))

is normalized into

intersect(inverse(spouse), inverse(wife))

is paraphrased into

```
intersect(spouse,
  restraint(spouse,,
    intersect(Resident, Restriction(sex,female,,1,1)),))
```

PROCESS 1431 paraphrases an exception property expression. It first distributes the inverse operator to each argument, and then paraphrases both arguments in the exception. For example,

inverse(except(spouse, wife))

is normalized into

except(inverse(spouse), inverse(wife))

is paraphrased into

```
except(spouse,
      restraint(spouse,,
composition(
    inverse(mother),
    restraint(
        spouse,,
        intersect(Resident, Restriction(sex,female,,1,1))))
```

PROCESS 1428 paraphrases an inverse restraint property expression. For example, let Resident be c, the expression,

inverse(restraint(spouse,,Man))

After moving the inverse into the restraint, the expression become inverse(spouse) and the domain becomes Man. It first invokes the paraphraseClasses to intersect the owner class and the domain. The result is

intersection(Resident, Restriction(sex, male, ,1,1)).

Then the paraphraselnverseProperty is used to paraphrase inverse(spouse). The result is

restraint(spouse, intersection(Resident, Restriction(sex, male,,1,1)),
)

PROCESS 1429 paraphrases a union property expression. It first distributes the inverse operator to each argument, then paraphrases all arguments in the union and removes all failed one if it is not definitive. For example, the expression

inverse(union(husband, wife))

intersect(Resident, Restriction(sex,female,,1,1)),))

PROCESS 1432 specifies that an inverse of an invocation, in general, cannot be paraphrased in the preferred embodiment. It is possible for an alternative embodiment to provide descriptions of an inverse operation on functions, so the inverse of invocation can be performed.

PROCESS 1433 adds back all class and property expressions of all auxiliary terms and the expressions of the terms they derived from into the query. Now all terms in the query will be either in the original target ontology or derived from terms in the original target ontology with expression in the query. For example, if grandparent is used, both

grandparent=PCOMPOSITE(parent,parent)
and
parent=PUNION(mother,father)

are added into the query.

Ouery Result Paraphrasing Process

The result of a paraphrased query is in the target ontology. Query result paraphrasing process paraphrases the result using the terms in the original query. There are many different ways to return result. The preferred embodiment uses a table style result. It is an RDF document consists of a single individual called QueryResult, which is a bag of columns of equal length. Each column is itself a bag containing the data. Bags' names are the result variable's name. Since all terms are in source ontology, there is no need to perform any answer paraphrasing.

FIG. 15 is an example of table result of a query. Statement 1501 shows an example of a query with two result variables, pn and ps, for the name and sex. Statement 1502 shows the RDF document of the result of the query.

An alternative is to return an XML document using QueryResult as its root. It requires no paraphrasing as before.

It should now be apparent that the above-described system allows data retrieval from ontology-oriented data systems over computer networks through a flexible system and method of query paraphrasing using a “common ontology”, e.g., an ontological categorization of terms that is not tied to any particular data system. This facilitates a query engine that can find what a user means, rather than simply what they type.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A process for data retrieval by querying a system regardless of the inherent query language of said data systems, comprising:
a first step of issuing a query in semantic query language comprising ontological query terms;
receiving said semantic query language query at a target data system;
determining whether any term of said semantic query is native to the target data system;
paraphrasing all terms of said semantic query that are not native to the target data system into the local ontology of the data system;
sending all paraphrased and native query terms to the target data system for processing.

2. The process for data retrieval according to claim 1, wherein said step of issuing a query in semantic query language comprises converting a query into a semantically equivalent query or a semantically implicative query.

3. The process for data retrieval according to claim 2, wherein said step of paraphrasing all terms of said semantic query comprises use of a conversion dictionary.

4. The process for data retrieval according to claim 1, further comprising a step of receiving a response from the native query terms sent to the target data system and translating back into the semantic query language.

5. In a system comprising a target data server for providing data in response to queries transmitted thereto in a localized ontology, a client computer capable of issuing a data query in a semantic query language using a common ontology, a query paraphrasing service in communication with said client computer and said target data server, and hosting software for translating data queries in said common ontology semantic query language to said localized ontology, said query paraphrasing service including a software dictionary for assisting in said translation, a method for paraphrasing semantic queries, comprising the steps of:
a query operation comprising issuing a data query from said client computer in a semantic query language using a common ontology;
a first paraphrasing operation comprising said query paraphrasing server paraphrasing said data query in said common ontology into said localized ontology.

6. The method according to claim 5, further comprising the step after said query operation of said target data server checking whether said issued data query is in the local ontology and, if not, transmitting said issued data query comprising to said query paraphrasing server for said paraphrasing operation.

7. The method according to claim 5, further comprising the step after said query operation of said client computer requesting said query paraphraser to paraphrase the issued query and then return the paraphrased query.

8. The method according to claim 5, further comprising the step after said query operation of said client computer requesting said query paraphraser to paraphrase the issued query and then returning a translation table to allow said client computer to derive the paraphrased query.

9. The method according to claim 5, wherein said system further comprises an answer paraphrasing service in communication with said client computer and said target data server and hosting software for translating said localized ontology answer of said target data server back into the common ontology of said client computer, said answer paraphrasing service including a software dictionary for assisting in said translation, and said method further comprises a second paraphrasing operation comprising said query paraphrasing server paraphrasing said data query in said localized ontology back into said common ontology.

10. A system for sharing data, comprising:
a target data server for providing data in response to queries transmitted thereto in a first localized ontology;
a client computer capable of issuing a data query in a common semantic ontology semantically equivalent to said first localized ontology;
a query paraphrasing service in communication with said client computer and said target data server, said query paraphrasing service including software for translating data queries in said common-ontology semantic query language into a semantically equivalent query or a semantically implicative query in local ontology native to said target data server.

11. The system for sharing data according to claim 10, wherein said query paraphrasing service includes a software dictionary for assisting in said translation.

12. The system for sharing data according to claim 11, wherein said software dictionary provides a look-up table of translations from various query languages into a canonical form query language.

13. The system for sharing data according to claim 11, further comprising an answer paraphrasing service including software for translating responses from said target data system back into said common-ontology semantic query language.

14. A process for classifying data in a data system based on context, comprising:
a first step of establishing a plurality of hierarchical context values for general variables, said context values including subcontext values for specific variables all capable of being a subset of said general variables;
a second step of establishing a set comprised of a plurality of assertions for any two context values for general variables, including 1) if an assertion of one context value is always equivalent to another context value and vica versa, then said context values are equivalent contexts, 2) if an assertion of one context value is always equivalent to another context value but not vica versa, then said one context value is a subcontext of said other context value.
